(19) United States
(12) Patent Application Publication
(10) Pub. No.: US 2026/0252004 A1
(43) Pub. Date: Aug. 27, 2026

(54) IMAGE FORMING APPARATUS

(71) Applicant: CANON KABUSHIKI KAISHA, Tokyo (JP)

(72) Inventors: TOMOHIRO SAITO, Chiba (JP); IZURU TANAKA, Kanagawa (JP)

(21) Appl. No.: 19/545,897

(22) Filed: Feb. 20, 2026

(30) Foreign Application Priority Data
Feb. 22, 2025 (JP) 2025-027427

(51) Int. Cl. G03G 15/16; G03G 15/01

(52) U.S. Cl. CPC G03G 15/1615; G03G 15/0131; G03G 15/0189; G03G 2215/00476; G03G 2215/00742

(57) ABSTRACT

An image forming apparatus includes an endless belt, stretching rollers, an outer member, a position changing mechanism, an acquiring portion, and a controller. Wherein when a tangential line common to the inner roller and an upstream roller is defined as a first reference line, a rectilinear line passing through an inner roller rotation center and perpendicular to the reference line is defined as a second reference line, a rectilinear line passing through an outer roller rotation center and perpendicular to the reference line is defined as a third reference line, and a distance between the second and third reference lines is defined as an offset amount, the controller is constituted so as to be capable of changing the offset amount on the basis of information on whether or not a recording material is embossed paper.

### BACKGROUND

### Field of the Technology

The present disclosure relates to an image forming apparatus, such as a copying machine, a printer, a plotter, a facsimile machine, or a multi-function machine having a plurality of functions of the machines, using an electrophotographic process or an electrostatic recording process.

### Description of the Related Art

Conventionally, as the image forming apparatus using the electrophotographic process or the like, there is an image forming apparatus using an endless belt as an image bearing member for bearing a toner image (hereinafter, this belt is simply referred to as a "belt"). As such a belt, for example, there is an intermediary transfer belt used as a second image bearing member for conveying the toner image primarily transferred from a photosensitive member or the like as a first image bearing member in order to secondarily transfer the toner image onto a sheet-like recording material such as paper. In the following, principally, an image forming apparatus employing an intermediary transfer type including the intermediary transfer belt will be described as an example.

In the image forming apparatus using the intermediary transfer belt, a transfer portion is formed by bringing a transfer roller or a transfer belt supported by the transfer roller into contact with the intermediary transfer belt, and in this transfer portion, the toner image carried on the intermediary transfer belt is transferred onto the recording material.

In such an image forming apparatus, it is preferable that the recording material is guided to the transfer portion by being superposed on the intermediary transfer belt in the neighborhood of a side upstream of the transfer portion with respect to a conveying direction of the recording material. This is because a strong electric field is generated under application of a high voltage to the transfer portion, and when the recording material is guided to the transfer portion by being superposed on the transfer roller or the transfer belt, electric discharge is generated between the intermediary transfer belt and the recording material and thus an image defect is liable to occur.

In order to stably convey the recording material to the transfer portion or the like purpose, a constitution in which a shape of a stretched surface of the intermediary transfer belt in the neighborhood of the side upstream of the transfer portion or a position of the transfer portion (herein, these are simply referred to as also a "state of transfer portion") with respect to the recording material conveying direction is changed has been known.

In Japanese Laid-Open Patent Application (JP-A) 2002-82543, a constitution in which a supporting member is provided on the side upstream of the transfer portion with respect to the recording material conveying direction and is caused to support an inner peripheral surface of the intermediary transfer belt, thereby to form a region, in which the recording material is superposed on the intermediary transfer belt, on the side upstream of the transfer portion has been disclosed.

Further, in JP-A 2011-64917, a constitution in which a position of a transfer roller is switched depending on information on a thickness or a basis weight of the recording material and thus a position (shape) of the transfer portion is changed has been disclosed.

However, in the conventional constitutions, in the case where the toner image is transferred onto embossed paper having unevenness on a surface onto which the toner image is transferred, electric discharge in a recessed portion of the embossed paper cannot be sufficiently suppressed in some instances. For that reason, a transfer void of a half-tone image or the like occurs in the recessed portion of the embossed paper in some instances.

### SUMMARY

The present disclosure is directed to improve a transfer property of a toner image onto embossed paper having unevenness on a surface onto which the toner image is transferred.

This is accomplished by an image forming apparatus according to the present disclosure.

According to an aspect of the present disclosure, there is provided an image forming apparatus comprising: a rotatable endless belt configured to convey a toner image; a plurality of stretching rollers including an inner roller configured to stretch the belt; an outer member contacting an outer peripheral surface of the belt and configured to form a transfer portion, in cooperation with the inner roller, where the toner image is transferred from the belt onto a recording material; a position changing mechanism configured to change a position of the transfer portion with respect to a circumferential direction of the inner roller by changing a position of at least one of the inner roller and the outer member; an acquiring portion configured to acquire information on whether or not the recording material onto which the toner image is transferred is embossed paper; and a controller configured to control the position changing mechanism on the basis of the information, wherein in a cross section perpendicular to a rotational axis direction of the inner roller, when a tangential line common to the inner roller and an upstream roller on a side where the belt is stretched is defined as a first reference line, a rectilinear line passing through a rotation center of the inner roller and perpendicular to the first reference line is defined as a second reference line, a rectilinear line passing through a rotation center of the outer member and perpendicular to the first reference line is defined as a third reference line, and a distance between the second reference line and the third reference line is defined as an offset amount which is positive value when the third reference line is positioned on a side upstream of the second reference line with respect to a rotational direction of the belt, the controller is constituted so as to be capable of changing the offset amount on the basis of the information.

According to another aspect of the photosensitive drum, there is provided an image forming apparatus comprising: a rotatable endless belt configured to convey a toner image; a plurality of stretching rollers configured to stretch the belt and including an inner roller and an upstream roller provided upstream of and adjacent to the inner roller with respect to a rotational direction of the belt; an outer member contacting an outer peripheral surface of the belt and configured to form a transfer portion, in cooperation with the inner roller, where the toner image is transferred from the belt onto a recording material; a pressing member provided upstream of the inner roller and downstream of the upstream roller with respect to the rotational direction of the belt and capable of pressing an inner peripheral surface of the belt; a changing mechanism capable of changing a curvature of the recording material in the transfer portion by changing a position of the transfer portion with respect to a circumferential direction of the inner roller by changing a position of the pressing member or by changing a position of at least one of the inner roller and the outer member; and a controller configured to be capable of controlling the changing mechanism so that the curvature of the recording material in the transfer portion becomes 25m-1 or more and 100m-1 or less in a case where the recording material onto which the toner image is transferred is embossed paper.

Further features of the present disclosure will become apparent from the following description of exemplary embodiments with reference to the attached drawings.

### BRIEF DESCRIPTION OF THE DRAWINGS

FIG. 1 is a schematic sectional view of an image forming apparatus.

Parts (a) and (b) of FIG. 2 are schematic side views showing a pressing mechanism.

FIG. 3 is a schematic block diagram showing a control mode of a principal part of the image forming apparatus according to an embodiment 1.

FIG. 4 is a graph showing a relationship between an angle of rotation of a pressing cam and a penetration amount.

Parts (a) and (b) of FIG. 5 are schematic side views showing an offset mechanism.

FIG. 6 is a schematic block diagram showing a control mode of a principal part of an image forming apparatus according to an embodiment 2.

FIG. 7 is a graph showing a relationship between an angle of rotation of an offset cam and penetration amount.

FIG. 8A is a schematic side view of a constitution provided with the pressing mechanism and an offset mechanism.

FIG. 8B is a schematic side view of a constitution provided with the pressing mechanism and the offset mechanism.

FIG. 8C is a schematic side view of a constitution provided with the pressing mechanism and the offset mechanism.

FIG. 9 is a schematic block diagram showing a control mode of a principal part of an image forming apparatus of the embodiment 3.

Parts (a) and (b) of FIG. 10 are schematic views each showing an example of a setting screen of an image forming mode.

FIG. 11 is a schematic view for illustrating a gap between a surface of a recording material and a surface of an intermediary transfer belt.

FIG. 12 is a graph for illustrating a relationship between the gap and a discharge current.

FIG. 13 is a schematic side view for illustrating a curvature of the recording material in a transfer portion.

FIG. 14 is a table showing a relationship between a penetration amount, an offset amount, and the curvature of the recording material in the transfer portion.

Parts (a) and (b) of FIG. 15 are schematic views for illustrating control of the curvature of the recording material in the transfer portion by the penetration amount and the offset amount.

FIG. 16 is a schematic sectional view for illustrating the offset amount.

Parts (a) and (b) of FIG. 17 are schematic sectional views for illustrating the penetration amount (pressing amount).

Parts (a) and (b) of FIG. 18 are schematic sectional views for illustrating a conveying attitude of a recording material.

### DESCRIPTION OF THE EMBODIMENTS

In the following, an image forming apparatus according to the present disclosure will be specifically described with reference to the drawings.

### Embodiment 1

1. General constitution and operation of image forming apparatus

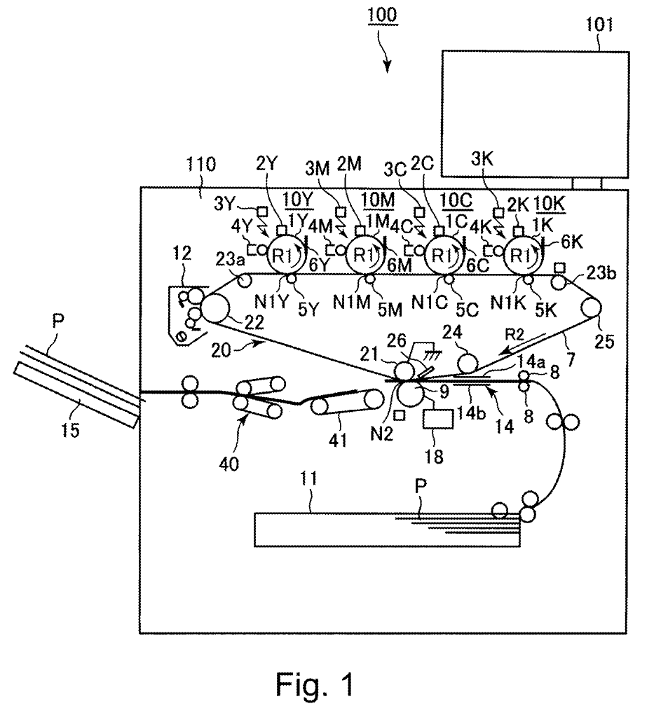

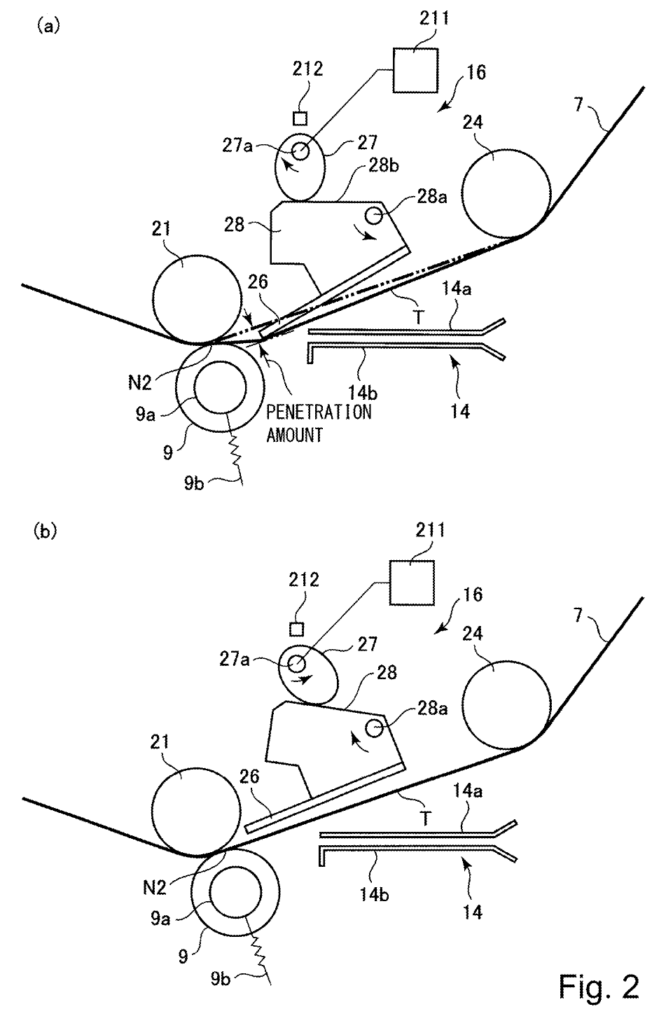

FIG. 1 is a schematic sectional view of an image forming apparatus 100 of this embodiment. The image forming apparatus 100 of this embodiment is a tandem multi-function machine (having functions of a copying machine, a printer, and a facsimile machine) which is capable of forming a full-color image using an electrophotographic process and which employs an intermediary transfer type. Depending on image information (image signal) read by an image reading apparatus or image information sent from an external device, the image forming apparatus 100 is capable of forming the full-color image on a sheet-like recording material (a sheet, a transfer material, a recording medium, media) P by using an electrophotographic process. As the external device (external equipment), it is possible to cite, for example, a host device such as a personal computer, or a digital camera, a smartphone, and the like. Incidentally, the recording material P is a material on which a toner image is formed, and a specific example thereof includes plain paper, a sheet made of synthetic resin which is a substitute for the plain paper, thick paper, embossed paper, a sheet for an overhead projector, and the like.

The image forming apparatus 100 includes, as a plurality of image forming portions (stations), four image forming portions 10Y, 10M, 10C, and 10K for forming images of yellow (Y), magenta (M), cyan (C), and black (K), respectively. These image forming portions 10Y, 10M, 10C, and 10K are disposed in line along a movement direction of an image transfer surface disposed substantially horizontal to an intermediary transfer belt 7. As regards elements, provided for the respective colors, having the same or corresponding functions or constitutions, suffixes Y, M, C and K for representing the elements for associated colors are omitted, and the elements will be collectively described in some instances. In this embodiment, the image forming portion 10 is constituted by including a photosensitive drum 1 (1Y, 1K, 1C, 1K), a charging device (charger) 2 (2Y, 2M, 2C, 2K), an exposure device 3 (3Y, 3M, 3C, 3K), a developing device 4 (4Y, 4M, 4C, 4K), a cleaning device 6 (6Y, 6M, 6C, 6K), and the like, which are described later.

To the photosensitive drum 1 which is a rotatable drum-shaped (cylindrical) photosensitive member (electrophotographic photosensitive member) as a first image bearing member for bearing a toner image, a driving force is transmitted from a drum driving motor (not shown) as a driving source, so that the photosensitive drum 1 is rotationally driven in an arrow R1 direction (counterclockwise direction) of FIG. 1. A surface of the rotating photosensitive drum 1 is electrically charged uniformly to a predetermined polarity (negative polarity in this embodiment) and a predetermined potential by the charging device 2 as a charging means. During a charging process, to the charging device 2, a predetermined charging voltage is applied from a charging power source (not shown). The charged surface of the photosensitive drum 1 is subjected to scanning exposure to light depending on the image information by the exposure device 3 as an exposure means (electrostatic image forming means), so that an electrostatic image (electrostatic latent image) is formed on the photosensitive drum 1. In this embodiment, the exposure device 3 is constituted by a laser scanner device for irradiating the surface of the photosensitive drum 1 with laser light modulated depending on the image information. The laser light emitted from a semiconductor laser of the exposure device 3 is deflected in a scanning direction by a rotatable polygonal mirror. The laser light deflected in a main scan direction is guided to the photosensitive drum 1 through reflection mirror, and the surface of the photosensitive drum 1 is exposed to light in the main scan direction, so that the electrostatic (latent) image is formed on the surface of the photosensitive drum 1. The electrostatic image formed on the photosensitive drum 1 is developed (visualized) by being supplied with toner as a developer by the developing device 4 as a developing means, so that a toner image (developer image) is formed on the photosensitive drum 1. In this embodiment, the toner charged to the same polarity (negative polarity in this embodiment) as a charge polarity of the photosensitive drum 1 is deposited on an exposed portion (image portion) of the photosensitive drum 1 where an absolute value of the potential is lowered by exposing the surface of the photosensitive drum 1 to light after the photosensitive drum 1 is uniformly charged (reverse development). In this embodiment, a normal charge polarity as a principal charge polarity of the toner during development is the negative polarity. The developing device 4 includes a developing roller, which is a rotatable developer carrying member, for conveying the developer to a developing position which is an opposing portion to the photosensitive drum 1 while carrying the developer. The developing roller is rotationally driven by transmitting thereto a driving force from a driving system for the photosensitive drum 1, for example. Further, during the development, to the developing roller, a predetermined developing voltage is applied from a developing power source (not shown).

As a second image bearing member for bearing the toner image, the intermediary transfer belt 7 which is a rotatable intermediary transfer member constituted by an endless belt is provided so as to oppose the four photosensitive drums 1Y, 1M, 1C, and 1K. The intermediary transfer belt 7 is provided so as to be contactable to the surface of the photosensitive drum 1. The intermediary transfer belt 7 is extended around and stretched under predetermined tension by a driving roller 22, an upstream auxiliary roller 23a, a downstream auxiliary roller 23b, a tension roller 25, a pre-secondary transfer roller 24 and an inner roller 21, which are as a plurality of stretching (supporting) rollers. The driving roller 22 transmits a driving force to the intermediary transfer belt 7. The tension roller 25 imparts the predetermined tension to the intermediary transfer belt 7, and controls the tension of the intermediary transfer belt 7 to a certain level. The pre-secondary transfer roller 24 forms a surface of the intermediary transfer belt 7 in the neighborhood of a secondary transfer nip N2 (described later) on a side upstream of the secondary transfer nip N2 with respect to a rotational direction (surface movement direction, traveling direction) of the intermediary transfer belt 7. The inner roller (secondary transfer opposite roller, inner member) 21 functions as an opposing member (opposite electrode) of an outer roller 9 (described later). The upstream auxiliary roller 23a and the downstream auxiliary roller 23b form the image transfer surface disposed substantially horizontally. The driving roller 22 is rotationally driven by transmission of the driving force thereto from a belt driving motor (not shown) as a driving source. By this, the driving force is inputted from the driving roller 22 to the intermediary transfer belt 7, so that the intermediary transfer belt 7 is rotated (circulated and moved) in an arrow R2 direction (clockwise direction) in FIG. 1. In this embodiment, the intermediary transfer belt 7 is rotationally driven so that a peripheral speed thereof is 150 - 470 m/sec. Incidentally, as regards a numerical range "to" means that the numerical range includes numerical values before and after "to".

On the inner peripheral surface side of the intermediary transfer belt 7, primary transfer rollers 5Y, 5M, 5C, and 5K which are roller-like primary transfer members as primary transfer means are provided correspondingly to the respective photosensitive drums 1Y, 1M, 1C, and 1K, respectively. The primary transfer roller 5 is disposed so as to operate the photosensitive drum 1 through the intermediary transfer belt 7. The primary transfer roller 5 presses the intermediary transfer belt 7 toward an associated photosensitive drum 1, so that a primary transfer nip N1 as a primary transfer portion which is a contact portion between the photosensitive drum 1 and the intermediary transfer belt 7 is formed. The stretching rollers other than the driving roller 22 and the respective primary transfers 5 are rotated by rotation of the intermediary transfer belt 7. Further, on an inner peripheral surface side of the intermediary transfer belt 7, a pressing member 26 is provided upstream of the inner roller 21 and downstream of the pre-secondary transfer roller 24 with respect to the rotational direction of the intermediary transfer belt 7. The pressing member 26 contacts an inner peripheral surface of the intermediary transfer belt 7 and is capable of pressing the intermediary transfer belt from the inner peripheral surface side toward an outer peripheral surface side. By this, the pressing member 26 is capable of causing a stretching surface T (FIG. 2) of the intermediary transfer belt 7 formed between the inner roller 21 and the pre-secondary transfer roller 24 to project from the inner peripheral surface side toward the outer peripheral surface side of the intermediary transfer belt 7. The pressing member 26 and a pressing mechanism 16 (FIG. 2) for changing a position of this pressing member 26 will be further described later.

The toner image formed on the photosensitive drum 1 as described above is primarily-transferred onto the rotating intermediary transfer belt 7 in the primary nip N1 by the action of the primary transfer roller 5.

During the primary transfer, to the primary transfer roller 5, a primary transfer voltage which is a DC voltage, which is subjected to constant voltage control, of an opposite polarity (positive polarity in this embodiment) to the normal charge polarity of the toner is applied by a primary transfer power source (not shown). For example, during full-color image formation, the color toner images of yellow, magenta, cyan, and black formed on the respective photosensitive drums 1 are successively primarily-transferred superposedly onto the same image forming region of the intermediary transfer belt 7. In this embodiment, the primary transfer nip N1 is an image forming position where the toner image is formed on the intermediary transfer belt 7. Further, the intermediary transfer belt 7 is an example of a rotatable endless belt for conveying the toner image carried in the image forming position.

On an outer peripheral surface side of the intermediary transfer belt 7, in a position opposing the inner roller 21, an outer roller (secondary transfer roller, outer member) 9 which is a roller-like secondary transfer member (rotatable transfer member) as a secondary transfer means is provided. The outer roller 9 is pressed toward the inner roller 21 through the intermediary transfer belt 7 and forms the secondary transfer nip N2 as a secondary transfer portion which is a contact portion between the intermediary transfer belt 7 and the outer roller 9. The toner images formed on the intermediary transfer belt 7 as described above are secondarily-transferred onto a recording material P nipped and conveyed by the intermediary transfer belt 7 and the outer roller 9 in the secondary transfer portion N2 by the action of the outer roller 9. In this embodiment, during the secondary transfer, to the outer roller 9, a secondary transfer voltage which is a DC voltage, subjected to the constant-voltage control, of the opposite polarity (positive polarity in this embodiment) to the normal charge polarity of the toner is applied by a secondary transfer power source (high-voltage applying means) 18. In this embodiment, for example, the secondary transfer voltage of +1 to +7 kV is applied and thus a secondary transfer current of +40 to +120 μA is caused to flow, so that the toner images are transferred from the intermediary transfer belt 7 onto the recording material P. In this embodiment, the inner roller 21 is electrically grounded (connected to the ground). Incidentally, the inner roller 21 is used as a secondary transfer member and a secondary transfer voltage of the same polarity as the normal charge polarity of the toner is applied thereto, and the outer roller 9 is used as an opposite electrode and may also be electrically grounded.

The recording material P is conveyed to the secondary transfer nip N2 by being timed to the toner image on the intermediary transfer belt 7. That is, the recording material P accommodated in a recording material cassette 11 as a recording material accommodating portion is conveyed to a pair of registration rollers (registration roller pair) 8 which is a conveying member as a conveying means by a feeding roller or the like as a feeding means (feeding member) constituting a feeding portion (feeding device), and is once stopped by the registration rollers 8. Then, this recording material P is sent into the secondary transfer nip N2 by rotational drive of the registration rollers 8 so that the toner image on the intermediary transfer belt 7 coincides with a desired image forming region on the recording material P in the secondary transfer nip N2.

With respect to the conveying direction of the recording material P, a conveying guide 14 for guiding the recording material P to the secondary transfer nip N2 is provided downstream of the registration rollers pairs 8 and upstream of the secondary transfer nip N2. The conveying guide 14 improves conveyance accuracy when the recording material P is supplied to the secondary transfer nip N2. The conveying guide 14 is constituted by including a first guiding member 14a contactable to a front surface of the recording material P (i.e., a surface onto which the toner image is to be transferred immediately after the recording material P passes through the conveying guide 14) and a second guiding member 14b contactable to a back surface of the recording material P (i.e., a surface opposite from the front surface). The first image guiding member 14a and the second guiding member 14b are disposed opposed to each other, and the recording material P passes through between these (both) members. The first guiding member 14a restricts movement of the recording material P in a direction toward the intermediary transfer belt 7. The second guiding member 14b restricts movement of the recording material P in a direction away from the intermediary transfer belt 7.

The recording material P on which the toner images are transferred is conveyed by a pre-fixing conveying device 41 toward a fixing device 40 as a fixing means. The pre-fixing conveying device 41 includes a rotatable belt member formed, at a central portion with respect to a direction substantially perpendicular to the conveying direction of the recording material P, of a rubber material such as EPDM, having a width of 100 to 110 mm with respect to the conveying direction and a thickness of 1 to 3 mm. The pre-fixing conveying device 41 conveys the recording material P while carrying the recording material P on the belt member. This belt member is perforated with holes of 3 to 7 mm in diameter, and air is sucked from the inner peripheral surface side, so that a carrying force of the recording material P is enhanced and thus a conveying property of the recording material P is stabilized. The fixing device 40 heats and presses the recording material P carrying thereon unfixed toner images in a process in which the recording material P is nipped and conveyed by a rotatable fixing member pair and thus fixes (melts), sticks the toner images on the surface of the recording material P. Thereafter, the recording material P on which the toner images are fixed is discharged (outputted) to a discharge tray 15 provided on an outside of an apparatus main assembly 110 of the image forming apparatus 100 by discharging rollers or the like which are a discharging members as discharging means.

On the other hand, toner (primary transfer residual toner) remaining on the photosensitive drum 1 after the primary transfer is removed and collected from the surface of the photosensitive drum 1 by the cleaning device 6 as a cleaning means. Further, deposited matters such as toner (secondary transfer residual toner) remaining on the intermediary transfer belt 7 after the secondary transfer, and paper powder deposited from the recording material P are removed and collected from the surface of the intermediary transfer belt 7 by a belt cleaning device 12 as an intermediary transfer member cleaning means. In this embodiment, the belt cleaning device 12 electrostatically collects and removes the deposited matters such as the secondary transfer residual toner and the like on the intermediary transfer belt 7.

Incidentally, in this embodiment, an intermediary transfer belt unit 20 as a belt conveying device is constituted by including the intermediary transfer belt 7 stretched by the plurality of stretching rollers, the respective primary transfer rollers 5, the belt cleaning device 12, a frame supporting these members, and the like. The intermediary transfer belt unit 20 is mountable to and demountable from the apparatus main assembly 110 for maintenance and exchange.

Here, as the intermediary transfer belt 7, a belt constituted by a resin-based material formed in a single layer structure or a multi-layer structure , a belt having a multi-layer structure including an elastic layer constituted by an elastic material, and the like can be used.

Further, in this embodiment, the primary transfer roller 5 is constituted by providing an elastic layer formed with an ion-conductive foam rubber on an outer peripheral surface of a core metal (core material) made of metal. Further, in this embodiment, the primary transfer roller 5 is 15 to 20 mm in outer diameter and is 1x105 to 1x108 Ω in electric resistance value in the case where the electric resistance is measured under application of a voltage of 2 kV in an environment of 23°C and 50 %RH.

Further, in this embodiment, the outer roller 9 is constituted by providing an elastic layer formed with an ion-conductive foam rubber on an outer peripheral surface of a core metal (core material) made of metal. Further, in this embodiment, the outer roller 9 is 20 to 25 mm in outer diameter and is 1x105 to 1x108 Ω in electric resistance value in the case where the electric resistance is measured under application of the voltage of 2 kV in the environment of 23°C and 50 %RH. Further, in this embodiment, the outer roller 9 is rotatably supported by bearings 9a (FIG. 2) at opposite end portions thereof with respect to a rotational axis direction. The bearings 9a are slidable and movable in a direction toward the inner roller 21 and in a direction opposite to the direction, and are pressed toward the inner roller 21 by pressing springs 9b (FIG. 2) constituted by compression springs which are urging members (elastic members) as urging means. By this, the outer roller 9 contacts the intermediary transfer belt 7 toward the inner roller 21 at predetermined pressure and forms the secondary transfer nip N2.

Further, in this embodiment, the inner roller 21 is constituted by providing an elastic layer formed with an electroconductive rubber on an outer peripheral surface of a core metal (core material) made of metal. Further, in this embodiment, the inner roller 21 is 20 to 22 mm in outer diameter and is 1x105 to 1x108 Ω in electric resistance value in the case where the electric resistance value is measured under application of a voltage of 50 V in the environment of 23°C and 50 %RH. Incidentally, the pre-secondary transfer roller 24 may also have the same constitution as the constitution of the inner roller 21, for example.

Further, in this embodiment, rotational axis directions of the stretching rollers including the inner roller 21 for the intermediary transfer belt 7 and the outer roller 9 are substantially parallel to each other.

2. Pressing member and pressing mechanism

Next, the pressing member 26 and the pressing mechanism 19 for changing the position of this pressing member 26 will be described. Parts (a) and (b) of FIG. 2 are schematic side views of a principal part of a portion in the neighborhood of the secondary transfer nip N2 in this embodiment as seen from a one end portion side (front side on the drawing sheet of FIG. 1) with respect to a rotational axis direction of the inner roller 21 in a direction substantially parallel to the rotational axis direction. Part (a) of FIG. 2 shows a state in which the pressing member 26 presses the intermediary transfer belt 7 with a predetermined pressing force, and part (b) of FIG. 2 shows a state in which the pressing member 26 is separated (spaced) from the intermediary transfer belt 7. In parts (a) and (b) of FIG. 2, a structure at the one end portion of the inner roller 21 with respect to the rotational axis direction of the inner roller 21 is shown, but a structure at the other end portion of the inner roller 21 is similar thereto (i.e., is substantially symmetrical therewith with respect to a center with respect to the rotational axis direction of the inner roller 21).

In this embodiment, the image forming apparatus 100 includes a sheet-like pressing member (back-up sheet) 26. The pressing member 26 is capable of causing the intermediary transfer belt 7 to project toward the outer peripheral surface side by pressing the inner peripheral surface of the intermediary transfer belt 7 in the neighborhood of the secondary transfer nip N2. With respect to the rotational direction of the intermediary transfer belt 7, the pressing member 26 is disposed upstream of the inner roller 21 and downstream of the pre-secondary transfer roller 24 so as to be contactable to the inner peripheral surface of the intermediary transfer belt 7. Particularly, in this embodiment, with respect to the conveying direction of the recording material P, the pressing member 26 is disposed so as to be contactable to the inner peripheral surface of the intermediary transfer belt 7 in a position corresponding to a position upstream of the inner roller 21 and downstream of a free end of the conveying guide 14 (first guiding member 14a) on a downstream side.

The pressing member 26 can be formed with a resin material. As the resin material forming the pressing member 26, for example, polyester resin or the like such as PET resin can be used suitably. In this embodiment, the pressing member 26 is constituted by a plate-like member which has a predetermined length with respect to each of a longitudinal direction substantially parallel to a widthwise direction of the intermediary transfer belt 7 (substantially perpendicular to a surface movement direction of the intermediary transfer belt 7) and a short-side direction substantially perpendicular to the longitudinal direction and which has a predetermined thickness. The length of the pressing member 26 with respect to the longitudinal direction is equal to the length of the intermediary transfer belt 7 with respect to the widthwise direction. Further, the pressing member 26 includes a free end portion, which is one end portion (end portion on a downstream side of the rotational direction), contactable to the inner peripheral surface of the intermediary transfer belt 7 over a substantially full width of the intermediary transfer belt 7 and capable of pressing the intermediary transfer belt 7. Further, as an example, the pressing member 26 is about 0.4 to 0.6 mm in thickness.

Here, as the pressing member 26, for example, a PET resin sheet adjusted in electric resistance to a medium resistance (for example, volume resistivity of 1x105 to 1x109 Ω.cm) can be used. By this, it is possible to suppress that a current flows through the pressing member 26, and it is possible to suppress that rotation of the intermediary transfer belt 7 is prevented due to attraction of the intermediary transfer belt 7 to the pressing member 26 by static electricity (triboelectric charge) caused by friction between the pressing member 26 and the intermediary transfer belt 7.

Incidentally, the pressing member 26 is not limited to the sheet-like member made of the resin material. The pressing member 26 may also be, for example, a sheet-like member constituted by a thin plate made of metal. Further, the pressing member 26 is not limited to the sheet-like member. The pressing member 26 may also be, for example, an elastic member (such as a pad-like elastic member) formed with a sponge, a rubber, or the like. Further, the pressing member 26 may also be, for example, a rigid member such as a rotatable roller made of resin, metal, or the like. Further, the pressing member 26 is not limited to one which is contacted to the intermediary transfer belt 7 by being disposed in a predetermined position as in this embodiment. For example, in the case where the rigid member such as the above-described rotatable roller is used as the pressing member 26 or in the like case, the pressing member 26 may also be urged toward the intermediary transfer belt 7 by a spring or the like as an urging means.

In this embodiment, the image forming apparatus 100 includes the pressing mechanism 16 as a position changing mechanism. The pressing mechanism 16 changes a position of the pressing member 26 and thus changes at least one (both in this embodiment) of a pressing amount of the pressing member 26 to the intermediary transfer belt 7 and a state in which the pressing member 26 is contacted to or separated (spaced) from the intermediary transfer belt 7. Incidentally, as described later, the pressing amount of the pressing member 26 to the intermediary transfer belt 7 can be represented by a penetration amount of the pressing member 26 into the intermediary transfer belt 7. Herein, the "pressing amount" is referred to as the "penetration amount") in some instances. Further, a change in penetration amount of the pressing member 26 into the intermediary transfer belt 7 is described as including a change in state in which the pressing member 26 is contacted to or separated from the intermediary transfer belt 7 in some instances. Further, a change (adjustment) in position of the pressing member 26 is described simply as a change (adjustment) in penetration amount in some instances.

The pressing member 26 is supported (held) by a pressing member holder 28 as a supporting member (holding member). The pressing member 26 is fixed to the pressing member holder 28 over a substantially full width thereof with respect to the longitudinal direction in a fixed end portion thereof which is one end portion (an upstream-side end portion with respect to the rotational direction of the intermediary transfer belt 7) with respect to the short-side direction thereof. The pressing member holder 28 is held by a frame or the like of the intermediary transfer belt unit 20 so as to be rotatable about a pressing member rotation shaft 28a. Thus, the pressing member holder 28 is rotated about the pressing member rotation shaft 28a, and thus the pressing member 26 is rotated about the pressing member rotation shaft 28a, so that the position of the pressing member 26 can be changed. By this, at least one (both in this embodiment) of the penetration amount of the pressing member 26 to the intermediary transfer belt 7 and the state in which the pressing member 26 is contacted to or separated from the intermediary transfer belt 7 can be changed.

The pressing member holder 28 is constituted so as to be rotated by the action of a pressing cam 27 as an acting member. The pressing cam 27 is held by the frame or the like of the intermediary transfer belt unit 20 so as to be rotatable about a pressing cam rotation shaft 27a. The pressing cam 27 is rotated about the pressing cam rotation shaft 27a by receiving drive from a pressing cam driving motor 211 as a driving source. Further, the pressing cam 27 contacts a cam follower 28b provided to the pressing member holder 28. Incidentally, the pressing member holder 28 may be urged by a tensile spring (not shown) or the like which is an urging member (elastic member) as an urging means so that the cam follower 28b is rotated in a direction in which the cam follower 28b engages with the pressing cam 27. Further, in this embodiment, the image forming apparatus 100 is provided with a pressing cam position sensor (cam HP sensor) 212 as a position detecting means for detecting a position of the pressing cam 27 with respect to the rotational direction, particularly a home position (HP) with respect to the rotational direction in this embodiment. The pressing cam position sensor 212 can be constituted by including, for example, a flag as an indicating portion provided on or coaxially with the pressing cam 27, a photo-interrupter as a detecting portion, and the like.

Thus, in this embodiment, the pressing mechanism 16 is constituted by including the pressing member holder 28, the pressing cam 27, the pressing cam driving motor 211, the pressing cam position sensor 212, and the like.

As shown in part (a) of FIG. 2, when the intermediary transfer belt 7 is pressed (or the penetration amount is increased) by the pressing member 26, the pressing cam 27 is rotated clockwise by being driven by the pressing cam driving motor 211. By this, the pressing member holder 28 is rotated in the counterclockwise direction about the pressing member rotation shaft 28a, so that a state in which the pressing member 26 is disposed in a position where the penetration amount of the pressing member 26 into the intermediary transfer belt 7 becomes a predetermined penetration amount (or becomes a larger predetermined penetration amount) is formed. At this time, a free end of the pressing member 26 contacts the inner peripheral surface of the intermediary transfer belt 7 and causes the intermediary transfer belt 7 to project toward the outer peripheral surface side.

Further, as shown in part (b) of FIG. 2, when the pressing member 26 is separated from the intermediary transfer belt 7 (or the penetration amount is decreased), the pressing cam 27 is rotated in the counterclockwise direction by being driven by the pressing cam driving motor 211. By this, the pressing member holder 28 is rotated clockwise about the pressing member rotation shaft 28a, so that a state in which the pressing member 26 is disposed in a position where the pressing member 26 is separated from the intermediary transfer belt 7 (or in a position where the penetration amount is a smaller predetermined penetration amount) is formed.

As shown in part (a) of FIG. 2, when the pressing member 26 contacts the intermediary transfer belt 7 and presses the intermediary transfer belt 7 with a predetermined pressing force, the stretched surface T of the intermediary transfer belt 7 is changed, so that the shape of the intermediary transfer belt 7 in the neighborhood of the secondary transfer nip N2 changes in direction in which the intermediary transfer belt 7 is wound about the outer roller 9. As described specifically later, by changing the penetration amount of the pressing member 26, a curvature of the recording material P in the secondary transfer nip N2 can be changed.

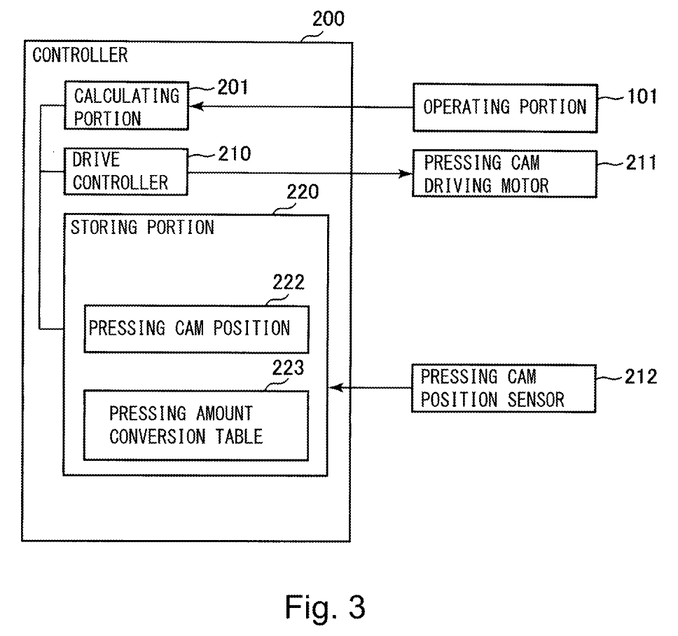

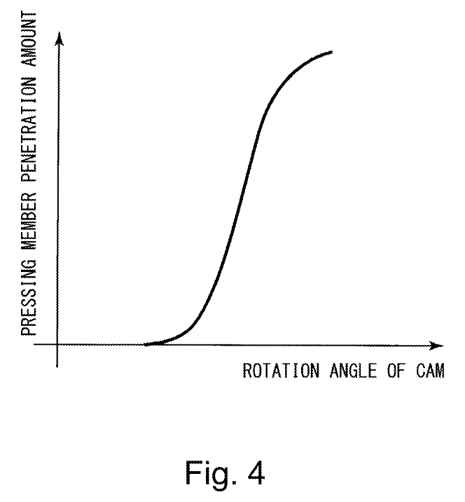

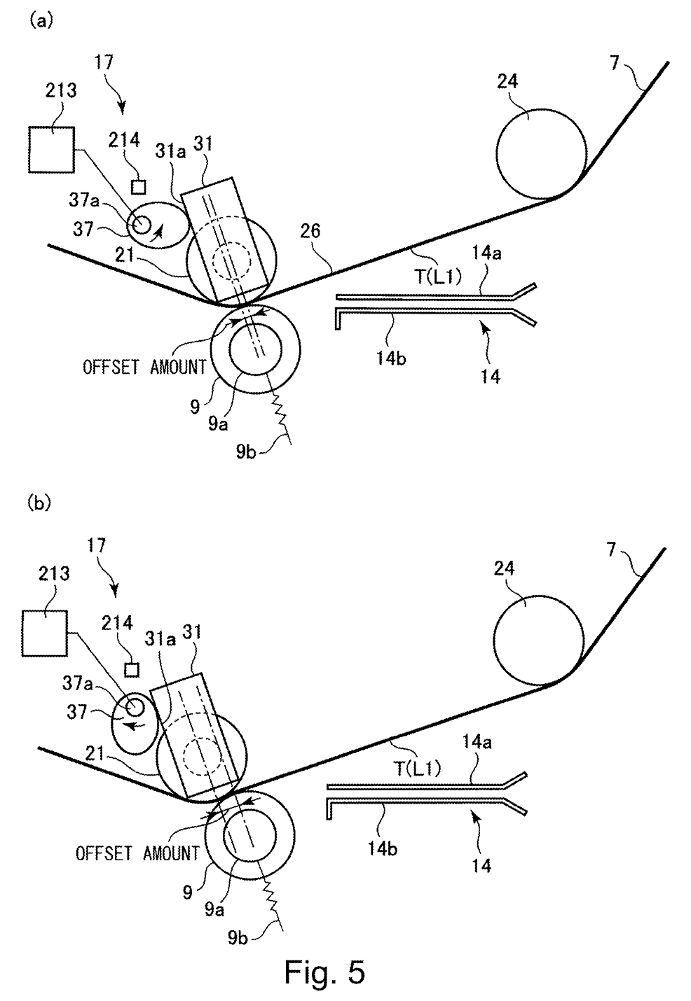

Further, in this embodiment, the pressing cam 27 has a shape such that the penetration amount of the pressing member 26 into the intermediary transfer belt 7 changes depending on an angle of rotation. By this, in this embodiment, by controlling the angle of rotation of the pressing cam 27, it becomes possible to adjust the penetration amount of the pressing member 26 into (against) the intermediary transfer belt 7. In this embodiment, a controller 200 (FIG. 3) described later controls the pressing cam driving motor 211, and thus carries out control so that the pressing member 26 presses the intermediary transfer belt 7 with the predetermined pressing force or so that the pressing member 26 is separated from the intermediary transfer belt 7. FIG. 4 is a graph showing a relationship between the angle of rotation of the pressing cam 27 and the penetration amount of the pressing member 26 into the intermediary transfer belt 7 in this embodiment.

In this embodiment, an initial set value (predetermined pressing force) of the pressing member 26 into the intermediary transfer belt 7 is set to, for example, 0 mm (separation) or a positive predetermined value. Further, in this embodiment, the pressing member 26 can be disposed in a position separated from the intermediary transfer belt 7 or in a position where the pressing member 26 contacts the intermediary transfer belt 7 with a penetration amount of 0 mm to 4.0 mm. Incidentally, the present disclosure is not limited thereto, but this penetration amount may suitably be about 5.0 mm or less. When the penetration amount is excessively larger, a load exerted on a contact surface between the pressing member 26 and the intermediary transfer belt 7 increases, and therefore, there is a possibility that the intermediary transfer belt 7 is not readily rotated smoothly.

Incidentally, it is desirable that the pressing member 26 is moved close to the inner roller 21 to the extent possible, but the pressing member 26 may desirably be disposed so as not to contact the inner roller 21. The pressing member 26 can be disposed so that the inner peripheral surface of the intermediary transfer belt 7 and the free end of the pressing member 26 are in contact with each other in a position, for example, about 2 mm or more, typically about 10 mm or more away from the position, where the inner roller 21 and the intermediary transfer belt 7 are in contact with each other, toward an upstream side of the rotational direction of the intermediary transfer belt 7. Further, the pressing member 26 can be disposed so that the inner peripheral surface of the intermediary transfer belt 7 and the free end of the pressing member 26 are in contact with each other in a position, for example, about 40 mm or less, typically about 25 mm or less away from the position, where the inner roller 21 and the intermediary transfer belt 7 are in contact with each other, toward the upstream side of the rotational direction of the intermediary transfer belt 7.

Further, the penetration amount of the pressing member 26 into the intermediary transfer belt 7 may only be required to be a predetermined value when the recording material P passes through the neighborhood of an entrance of the secondary transfer nip N2 and the secondary transfer nip N2. The neighborhood of the entrance of the secondary transfer nip N2 is specifically a region corresponding to a region of the intermediary transfer belt 7 from a position, where the pressing member 26 contacts the intermediary transfer belt 7, to the secondary transfer nip N2 with respect to the conveying direction of the recording material P.

Further, when the image forming apparatus 100 is left standing in a state in which the pressing member 26 is disposed in a position where the pressing member 26 presses the intermediary transfer belt 7, it causes deformation of the pressing member 26 with time in some instances. For that reason, for example, in an OFF state of a power source of the image forming apparatus 100 or in a sleep state of the image forming apparatus 100, as shown in part (b) of FIG. 2, the pressing member 26 can be disposed in a position where the pressing member 26 is separated from the intermediary transfer belt 7.

3. Penetration amount and offset amount

The penetration amount of the pressing member 26 into the intermediary transfer belt 7 will be further described. The pressing amount of the pressing member 26 against the intermediary transfer belt 7 can be represented by the following penetration amount of the pressing member 26 into the intermediary transfer belt 7. This penetration amount is roughly an amount such that the pressing member 26 causes the intermediary transfer belt 7 to project toward the outside with respect to the stretched surface (stretch surface) T of the intermediary transfer belt 7 formed by stretching the intermediary transfer belt 7 by the inner roller 21 or the outer roller 9 and the pre-secondary transfer roller 24. The pre-secondary transfer roller 24 is an example of an upstream roller, of a plurality of stretching rollers, disposed adjacent to the inner roller 21 on a side upstream of the inner roller 21 with respect to the rotational direction of the intermediary transfer belt 7.

This definition of the penetration amount specifically changes depending on an offset amount showing a relative position between the inner roller 21 and the outer roller 9 (a position of the secondary transfer nip N2) with respect to a circumferential direction of the inner roller 21.

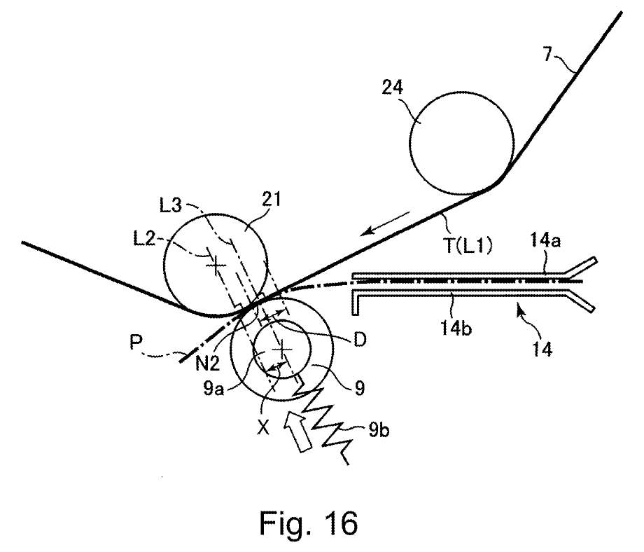

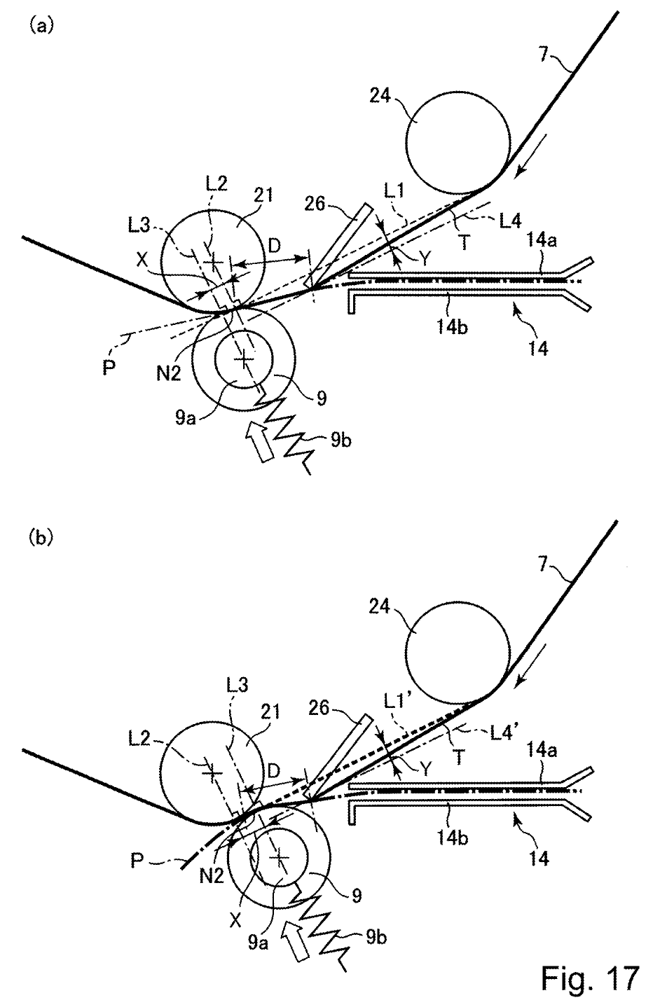

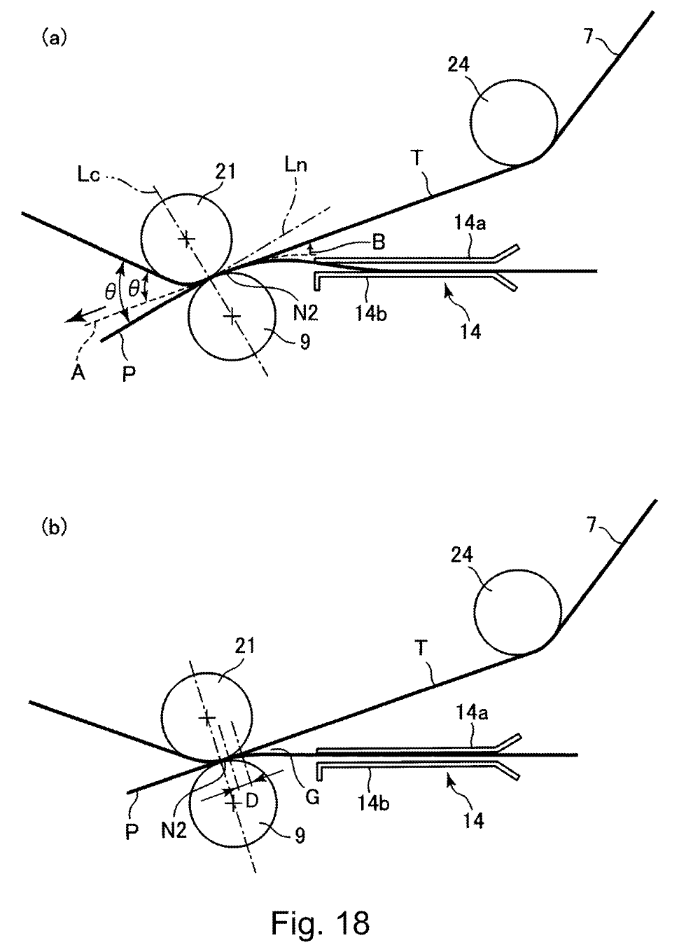

First, the offset amount will be described. FIG. 16 is a schematic sectional view (cross section substantially perpendicular to the rotational axis direction of the inner roller 21) of the neighborhood of the secondary transfer nip N2, for illustrating definition of an offset amount X indicating the relative position between the inner roller 21 and the outer roller 9.

In the cross section shown in FIG. 16, a common tangential line of the inner roller 21 and the pre-secondary transfer roller 24 on a side where the intermediary transfer belt 7 is extended around the stretching rollers is a reference line L1. The reference line L1 corresponds to the stretched surface T in the case where the intermediary transfer belt 7 is not projected to the outer peripheral side by the pressing member 26. Further, in the same cross section, a rectilinear line which passes through the rotation center of the inner roller 21 and which is substantially perpendicular to the reference line L1 is referred to as an inner roller center line L2. Further, in the same cross section, a rectilinear line which passes through the rotation center of the outer roller 9 and which is substantially perpendicular to the reference line L1 is referred to as an outer roller center line L3. At this time, a distance (vertical distance) between the inner roller center line L2 and the outer roller center line L3 is defined as the offset amount X (provided that the offset amount X is a positive value when the outer roller center line L3 is on the side upstream of the inner roller center line L2 with respect to the rotational direction of the intermediary transfer belt 7). The offset amount X can take a negative value, zero and the positive value. By making the offset amount X large, a width of the secondary transfer nip N2 with respect to the rotational direction of the intermediary transfer belt 7 extends toward an upstream side of the rotational direction of the intermediary transfer belt 7. That is, with respect to the rotational direction of the intermediary transfer belt 7, an upstream-side end portion of a contact region between the outer roller 9 and the intermediary transfer belt 7 is positioned on an upstream side than an upstream-side end portion of a contact region between the inner roller 21 and the intermediary transfer belt 7 is. Thus, it is possible to change a position of at least one of the inner roller 21 and the outer roller 9. By this, the relative position between the inner roller 21 and the outer roller 9 with respect to the circumferential direction of the inner roller 21 is changed, so that the position of the secondary transfer nip N2 (position of transfer portion, transfer roller) with respect to the circumferential direction of the inner roller 21 can be changed.

Next, the penetration amount will be described. Parts (a) and (b) of FIG. 17 are schematic sectional views (cross sections substantially perpendicular to the rotational axis direction of the inner roller 21) of the neighborhood of the secondary transfer nip N2, for illustrating definition of a penetration amount Y of the pressing member 26 into the intermediary transfer belt 7. Incidentally, the definition of the penetration amount Y is different between the case where the offset amount X is the positive value and the case where the offset amount X is 0 (zero) or the negative value. This is because in general whether the stretched surface T of the intermediary transfer belt 7 in a state in which the intermediary transfer belt 7 is not pressed by the pressing member 26 is formed by the inner roller 21 and the pre-secondary transfer roller 24 or by the outer roller 9 and the pre-secondary transfer roller 24 changes depending on the offset amount X. Part (a) of FIG. 17 shows the case where the offset amount X is 0 or the negative value (particularly the negative value), and part (b) of FIG. 17 shows the case where the offset amount X is the positive value.

First, the case where the offset amount X is 0 or the negative value will be described. In the cross section shown in part (a) of FIG. 17, the common tangential line of the inner roller 21 and the pre-secondary transfer roller 24 on the side where the intermediary transfer belt 7 is extended around the stretching rollers is the reference line L1. Further, in the same cross section, a tangential line of the intermediary transfer belt 7 which is substantially parallel to the reference line L1 and which contacts the outer peripheral surface of the intermediary transfer belt 7 in a region where the pressing member 26 contacts the intermediary transfer belt 7 is a pressing portion tangential line L4. At this time, in the case where the offset amount X is 0 or the negative value, a distance (vertical distance) between the reference line L1 and the pressing portion tangential line L4 is defined as the penetration amount Y of the pressing member 26 into the intermediary transfer belt 7 (provided that the penetration amount Y is the positive value when the pressing portion tangential line L4 is on the outer peripheral surface side of the intermediary transfer belt 7 than the reference line L1 is). This penetration amount Y can take 0 or the positive value.

Next, the case where the offset amount X is 0 or the positive value will be described. In the cross-section shown in part (b) of FIG. 17, the common tangential line of the outer roller 9 and the pre-secondary transfer roller 24 on the side where the intermediary transfer belt 7 is extended around the stretching rollers is the reference line L1'. Further, in the same cross-section, a tangential line of the intermediary transfer belt 7 which is substantially parallel to the reference line L1 and which contacts the outer peripheral surface of the intermediary transfer belt 7 in a region where the pressing member 26 contacts the intermediary transfer belt 7 is a pressing portion tangential line L4'. At this time, in the case where the offset amount X is the positive value, a distance (vertical distance) between the reference line L1' and the pressing portion tangential line L4' is defined as the penetration amount Y of the pressing member 26 into the intermediary transfer belt 7 (provided that the penetration amount Y is the positive value when the pressing portion tangential line L4' is on the outer peripheral surface side of the intermediary transfer belt 7 than the reference line L1' is). This penetration amount Y can take 0 or the positive value.

4. Control mode

FIG. 3 is a schematic block diagram showing a control mode of a principal part of the image forming apparatus 100 in this embodiment. The controller 200 as a control means is constituted by including a CPU as a calculation control means which is a dominant element for performing processing, memories (storing media) such as a ROM and a RAM which are used as storing means, and an interface portion (input/output circuit), and the like. In the RAM which is rewritable memory, information inputted to the controller 200, detected information, a calculation result, and the like are stored. In the ROM, a data table acquired in advance, and the like are stored. The CPU and the memories are capable of transferring and reading the data therebetween. The interface portion controls input and output (communication) of signals between the controller 200 and devices connected to the controller 200.

To the controller 200, respective portions (the image forming portions 10, the intermediary transfer belt unit 20, a conveying mechanism for the recording material P, driving devices, various power sources, and the like) of the image forming apparatus 100 are connected. In a relationship with this embodiment, the controller 200 includes an arithmetic (operation) portion 201, a drive controller 210, and a storing portion 220. In this embodiment, the arithmetic portion 201 and the drive controller 210 are realized by operating the above-described CPU in accordance with a predetermined program. Further, in this embodiment, the storing portion 220 is realized by the above-described memory. To the drive controller 210, driving means for driving respective portions of the image forming apparatus 100, such as the pressing cam driving motor 211, and further a drum driving motor, a belt driving motor, and the like motor are connected. By an instruction from the arithmetic portion 201, the drive controller 210 operates the driving means for driving the respective portions of the image forming apparatus 100, such as the pressing cam driving motor 211 and the like.

Further, to the controller 200, the operating portion (operating panel) 101 provided on the image forming apparatus 100 is connected. The operating portion 101 includes a display portion (display means) for displaying information by control of the controller 200 and an input portion (input means) for inputting information to the controller 200 through an operation by an operator such as a user or a service person (in this embodiment, represented by the user). The operating portion 101 may be constituted by including a touch panel having functions of the display means and the input means. Further, to the controller 200, an image reading apparatus (not shown) provided in or connected to the image forming apparatus 100 and an external device (not shown) such as a personal computer connected to the image forming apparatus 100 may also be connected.

The controller 200 causes the image forming apparatus 100 to perform the image forming operation by controlling the respective portions of the image forming apparatus 100 on the basis of information on a job. The job information includes a start instruction (start signal) and information (instruction signal) on an image forming condition such as a kind of the recording material P, which are inputted from the operating portion 101 or the external device. Further, the job information includes image information (image signals) inputted from the image reading apparatus, the external device or the operating portion 101. Incidentally, information on the kind of the recording material P encompasses arbitrary pieces of information capable of discriminating the recording material P, inclusive of attributes (so-called paper kind categories) based on general features such as plain paper, quality paper, coated paper, embossed paper, thick paper and thin paper, numerals and numerical ranges such as a basis weight, a thickness, a size and rigidity, and brands (including manufacturers, product numbers and the like); and the like.

The image forming apparatus 100 executes a job (print job, printing job) which is a series of operations which is started by a single start instruction and in which the image is formed and outputted on a single recording material P or a plurality of recording materials P. The job includes an image forming step (image forming operation, print operation, printing operation), a pre-rotation step, a sheet (paper) interval step in the case where the images are formed on the plurality of recording materials P, and a post-rotation step, in general.

The image forming step is a period in which formation of an electrostatic image for the image actually formed and outputted on the recording material P, formation of the toner image, primary transfer of the toner image and secondary transfer of the toner image are carried out, and during image formation (image forming period) refers to this period. Specifically, timings during the image formation are different from each other in positions where the respective steps including the formation of the electrostatic image, the toner image formation, the primary transfer of the toner image and the secondary transfer of the toner image are performed. The pre-rotation step is a period in which a preparatory operation, before the image forming step, from an input of the start instruction until the image is started to be actually formed. The sheet interval step is a period corresponding to an interval between a recording material P and a subsequent recording material P when the images are continuously formed on a plurality of recording materials P (continuous image formation). The post-rotation step is a period in which a post-operation (preparatory operation) after the image forming step is performed. During non-image formation (non-image formation period) is a period other than during the image formation and includes the pre-rotation step, the sheet interval step, the post-rotation step, and further includes a pre-multi-rotation step which is a preparatory operation during turning-on of a power source of the image forming apparatus 100 or during restoration from a sleep state. Incidentally, the sleep state (rest state) is, for example, a state in which supply of electric power to the respective portions of the image forming apparatus 100, other than the controller 200 (or a part thereof), is stopped and electric power consumption is made smaller than electric power consumption in a stand-by state, the power source of the image forming apparatus 100 is turned on and the image forming apparatus 100 stands by for the job. In this embodiment, during the non-image formation, typically in the stand-by state, the image forming apparatus 100 is capable of executing an operation for adjusting the penetration amount Y described later.

5. Adjustment of position of pressing member

Next, an adjusting method of the penetration amount Y (position of the pressing member 26) in this embodiment will be specifically described.

As shown in FIG. 3, in this embodiment, in the storing portion 220, pressing cam position information 222 acquired from the pressing cam position sensor 212 for detecting the home position (HP) of the pressing cam 27 is stored. Further, in this embodiment, in the storing portion 220, a pressing amount conversion table 223 for rotationally driving the pressing cam 27 to a predetermined position is stored.

The pressing amount conversion table 223 shows a relationship between the angle of rotation of the pressing cam 27 and the penetration amount Y as shown in FIG. 4. On the basis of the pressing amount conversion table 223 and the pressing cam position information 222, the arithmetic portion 201 acquires the angle of rotation of the pressing cam 27 necessary to adjust the penetration amount Y to a predetermined penetration amount Y. Then, depending on a result thereof, the pressing cam 27 is rotated by operating the pressing cam driving motor 211 by a necessary control amount by the drive controller 210.

In this embodiment, as described later, the user provides an instruction from an input portion of the operating portion 101 to the controller 200 so as to perform an operation in an image forming mode. Further, the arithmetic portion 201 of the controller 200 reflects information on the penetration amount Y corresponding to the image forming mode designated by the user through the input portion of the operating portion 101 in an operation of the pressing cam driving motor 211. The information on the penetration amount Y corresponding to each image forming mode is set in advance and stored in the storing portion 220. Incidentally, in this embodiment, an instruction on selection of the operation in the image forming mode is provided from the operating portion 101. In this case, the operating portion 101 functions as an acquiring portion for acquiring information on the kind of the recording material P on which the image is formed. Further, in this case, the operating portion 101 can be said that the operating portion 101 functions as the input portion for inputting the information on the kind of the recording material P on which the image is formed, to the controller 200. However, the instruction on selection of the operation in the image forming mode may be provided from the external device communication connected to the image forming apparatus 100. In this case, the above-described interface portion (input/output circuit) or the like functions as the acquiring portion for acquiring the information on the kind of the recording material P on which the image is formed. Further, in this case, the interface portion (input/output circuit) or the like can also be said that the interface portion functions as the input portion for inputting the information on the kind of the recording material P on which the image is formed, to the controller 200.

6. Transfer void in embossed paper

Next, a problem in the case where the toner image is transferred onto a surface, on which the toner image is to be transferred, of embossed paper having unevenness will be further described. Incidentally, the embossed paper is paper (fancy paper) with a pattern by unevenness by using a method such as embossing or stamping on the surface of paper.

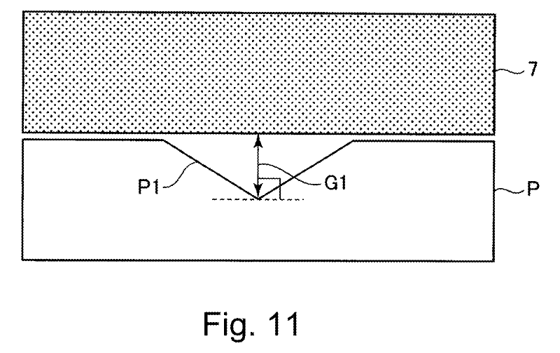

FIG. 11 is a schematic sectional view of a contact portion between the embossed paper as the recording material P and the intermediary transfer belt 7. As shown in FIG. 11, in the case where the toner image is transferred onto the embossed paper as the recording material P, in a recessed portion P1 of the surface of the recording material P on which the toner image is transferred, a gap G1 is formed between the surface of the recording material P on the intermediary transfer belt 7 side and the surface of the intermediary transfer belt 7. The gap G1 is represented by a length of a perpendicular line when the perpendicular line is drawn to the intermediary transfer belt 7 from a position of the surface of the recording material P, on the intermediary transfer belt 7 side, remotest from the intermediary transfer belt 7.

In the position where the gap G1 is formed, in the case where there is a potential difference between the recording material P and the intermediary transfer belt 7, a discharge current generates and a charge polarity of the toner constituting the toner image on the intermediary transfer belt 7 is reversed (in this embodiment, reversed from the negative polarity to the positive polarity) in some instances. Thus, when the charge polarity of the toner on the intermediary transfer belt 7 is reversed, the toner cannot be transferred onto the recording material P. Such a phenomenon is referred to as a transfer void. For example, in a recessed portion of the embossed paper, the transfer void of a half-tone image or the like occurs in some instances.

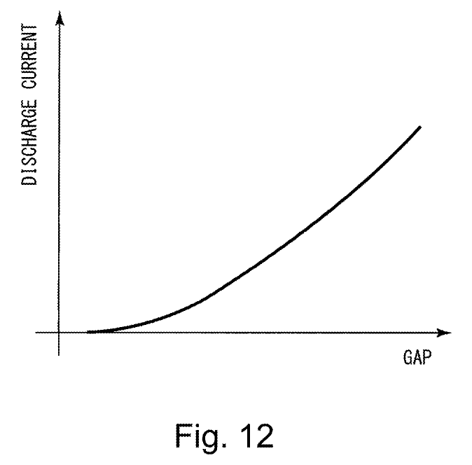

FIG. 12 is a graph for illustrating a relationship between a magnitude of the gap G1 and the discharge current. As shown in FIG. 12, in the case where the potential difference between the recording material P and the intermediary transfer belt 7 is a constant value, when the gap G1 becomes large, the discharge current becomes large. That is, the transfer void is liable to occur with a deep depth of the recessed portion of the embossed paper.

7. Curvature of recording material

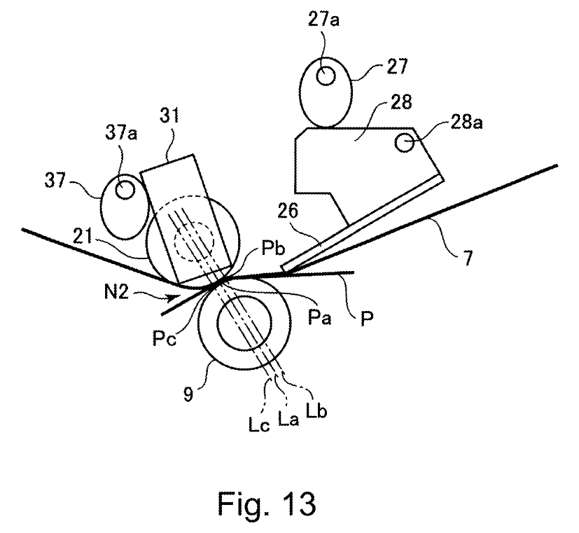

Next, a curvature of the recording material P in the secondary transfer nip N2 will be described. FIG. 13 is a schematic sectional view, of a principal part in the neighborhood of the secondary transfer nip N2, for illustrating a curvature of the recording material P in the secondary transfer nip N2 as viewed substantially parallel to a rotational axis direction of the inner roller 21 from one end portion side (front side of the drawing sheet of FIG. 1) of the inner roller 21 with respect to the rotational axis direction. Incidentally, in FIG. 13, an offset mechanism described in an embodiment 2 and an embodiment 3 is also shown.

As shown in FIG. 13, in the secondary transfer nip N2, the recording material P is conveyed in a shape along shapes of the outer roller 9 and the intermediary transfer belt 7. The curvature of the recording material P in the secondary transfer nip N2 can be defined as follows. A rectilinear line connecting a rotation center of the outer roller 9 and a rotation center of the inner roller 21 is defined as a rectilinear line La, a point of intersection of the rectilinear line La and the recording material P is defined as a coordinate Pa, a rectilinear line which is parallel to the rectilinear line La and which is positioned in a position spaced from the rectilinear line La toward an upstream side with respect to the conveying direction of the recording material P by 0.5 mm is defined as a rectilinear line Lb, a point of intersection of the rectilinear line Lb and the recording material P is defined as a coordinate Pb, a rectilinear line which is parallel to the rectilinear line La and which is positioned in a position spaced from the rectilinear line La toward a downstream side with respect to the conveying direction of the recording material P by 0.5 mm is defined as a rectilinear line Lc, and a point of intersection of the rectilinear line Lc and the recording material P is defined as a coordinate Pc. At this time, a reciprocal (inverse) (unit: m-1) of a radius of a circle determined by the coordinates Pa, Pb, and Pc is defined as the curvature of the recording material P in the secondary transfer nip N2.

8. Control of curvature of recording material

By changing a state of the secondary transfer nip N2, such as a shape of the stretched surface T of the intermediary transfer belt 7 on the side upstream of the secondary transfer nip N2 with respect to the conveying direction of the recording material P and a position of the secondary transfer nip N2, the curvature of the recording material P in the secondary transfer nip N2 can be changed. In addition, as a result of study by the present inventors, it turned out that a depth of the recessed portion of the embossed paper in the secondary transfer nip N2 can be made apparently shallow by increasing the curvature of the embossed paper in the secondary transfer nip N2. Incidentally, a distance from a minimum value to a maximum value of a height (depth) of the recessed portion of the embossed paper is defined as the depth of the recessed portion of the embossed paper.

In order to increase the curvature of the recording material P in the secondary transfer nip N2, it is effective that the penetration amount Y of the pressing member 26 is made large or that the offset amount X is made large. In this embodiment, an example of the case where the image forming apparatus 100 includes the pressing mechanism 16 for changing the penetration amount Y and does not include the offset mechanism for changing the offset amount X is shown, but for convenience, a change in curvature by the penetration amount Y and the offset amount X will be collectively described in this embodiment. The offset mechanism will be described in the embodiment 2 and the embodiment 3.

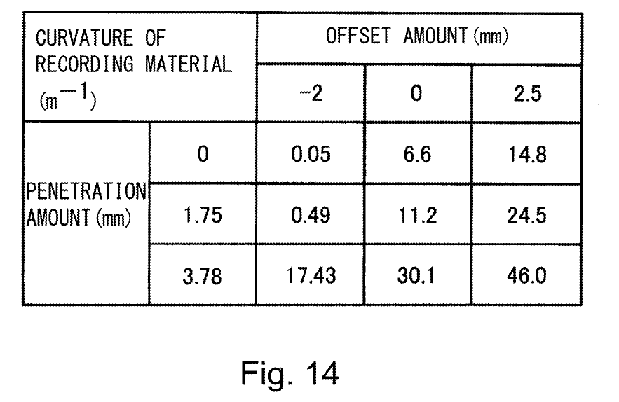

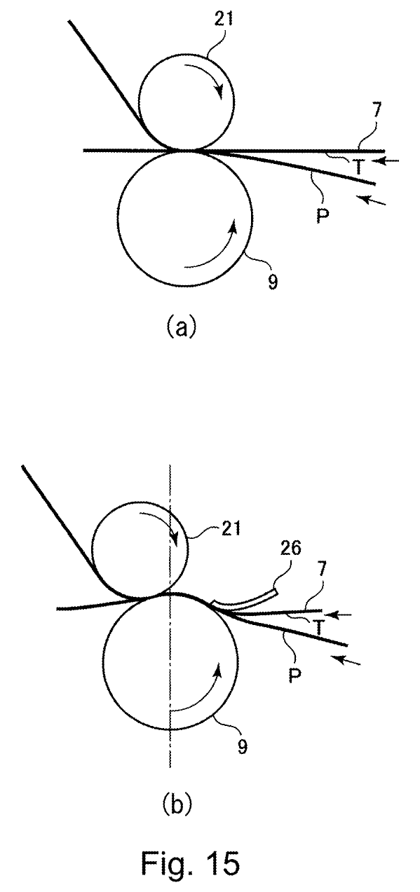

FIG. 14 is a table showing a result such that a conveyance state of the recording material P in the case where the penetration amount Y and the offset amount X are changed is measured and the curvature of the recording material P in the secondary transfer nip N2 is acquired. As the recording material P, as an example, paper ("LEATHAC 66", A4T white, 250.1g, manufactured by Tokushu Tokai Paper Co., Ltd.) was used. As is understood from FIG. 14, the curvature of the recording material P in the secondary transfer nip N2 can be changed by changing the penetration amount Y or the offset amount X. Specifically, by changing either one of the penetration amount Y and the offset amount X, the curvature of the recording material P in the secondary transfer nip N2 can be changed. In addition, by changing both the penetration amount Y and the offset amount X, depending on a combination of the penetration amount Y and the offset amount X, the curvature of the recording material P in the secondary transfer nip N2 can be changed.

As is understood from FIG. 14, by making the penetration amount Y large, the curvature of the recording material P in the secondary transfer nip N2 can be made large. In addition, by making the offset amount X in the positive direction large, the curvature of the recording material P in the secondary transfer nip N2 can be made large. Further, in the case where both the penetration amount Y and the offset amount X are changed, the curvature of the recording material P in the secondary transfer nip N2 can be changed more than that in the case where either one of the penetration amount Y and the offset amount X is changed.

This is because the stretched surface T of the intermediary transfer belt 7 is changed in a direction in which the stretched surface T is wound around the outer roller 9 in the case where the penetration amount Y is large as shown in part (b) of FIG. 15 more than in the case where the penetration amount Y is small (or zero) as shown in part (a) of FIG. 15. In addition, there is because the stretched surface T of the intermediary transfer belt 7 is changed in the direction in which the stretched surface T is wound around the outer roller 9 in the case where the offset amount X is relatively large as shown in part (b) of FIG. 15 more than in the case where the offset amount X is relatively small as shown in part (a) of FIG. 15. These are capable of synergistically acting on each other.

Further, with a larger curvature of the embossed paper in the secondary transfer nip N2, the recessed portion of the embossed paper is expanded, so that the depth of the recessed portion becomes apparently smaller as described above. By this, the transfer void when the toner image is transferred onto the embossed paper is suppressed, so that a transfer property of the toner image onto the embossed paper can be improved.

According to study by the present inventors, in order to make the transfer property of the toner image onto the embossed paper better, the curvature of the recording material P in the secondary transfer nip N2 may preferably be made 25m-1 or more, further preferably be made 45m-1 or more. Incidentally, although the present disclosure is not limited thereto, the curvature of the recording material P in the secondary transfer nip N2 is sufficient in many cases when the curvature is 100m-1 or less, and is appropriate when the curvature is 70m-1 or less, typically 50m-1 or less.

9. Image formation on embossed paper

Next, an example of a method in which the curvature of the recording material P in the secondary transfer nip N2 when the toner image is transferred onto the embossed paper will be described.

### Specific example 1

The image forming apparatus 100 is capable of forming an image in an operation in a normal mode (first mode) in which the toner image is transferred onto the recording material P which is not the embossed paper and in an operation in an embossed paper mode (second mode) in which the toner image is transferred onto the recording material P which is the embossed paper. The curvature of the recording material P in the secondary transfer nip N2 in the operation in the second mode is larger than the curvature of the recording material P in the secondary transfer nip N2 in the operation in the first mode.

Part (a) of FIG. 10 is a schematic view showing an example of an operating screen 300 (selecting screen of the image forming mode) displayed on the operating portion 101. In this embodiment, the operating portion 101 is constituted by including a touch panel, and the operating screen 300 is displayed on this touch panel. The operating screen 300 is displayed on the operating portion 101 by control of the controller 200 through a predetermined operation by the user on a main screen (not shown) displayed on the operating portion 101. Further, the user operates (touches) a predetermined button displayed on the operating screen 300, so that a predetermined signal associated with this button is inputted from the operating portion 101 to the controller 200.

In the example of part (a) of FIG. 10, the operating screen 300 is provided with a selecting portion 301 for selecting whether or not the operation in the embossed paper mode is enabled. "ON" of the selecting portion 301 is selected, so that the operation in the embossed paper mode is enabled. Further, a determining portion (OK button) 302 provided on the operating screen 300 is operated, so that a signal indicating that the operation in the embossed paper mode is enabled is outputted from the operating portion 101 to the controller 200. In the case where the operation in the embossed paper mode is not enabled, i.e., in the case where image formation is carried out by the operation in the normal mode, "OFF" of the selecting portion 301 is selected, so that similarly as described above, a signal indicating that the operation in the embossed paper mode is disabled (that the operation in the normal mode is selected) is outputted from the operating portion 101 to the controller 200. By this, the controller 200 is capable of acquiring an instruction as to whether or not the image formation should be executed in either one of the operation in the normal mode and the operation in the embossed paper mode. That is, the controller 200 is capable of acquiring an instruction as to whether or not the embossed paper is used as the recording material P. Incidentally, the normal mode can be made a default mode. Then, on the basis of this information, the controller 200 executes an operation for adjusting the penetration amount Y in the above-described manner. For example, in the case where the transfer void occurs when the image is formed on the embossed paper and is outputted, the user is capable of alleviating the transfer void by enabling the operation in the embossed paper mode.

For example, the controller 200 is capable of controlling the pressing mechanism 16 so that the penetration amount Y is adjusted in the following manner depending on the image forming mode. That is, as an example, the controller 200 is capable of controlling the pressing mechanism 16 so that the penetration amount Y becomes 0 mm (or 1.75 mm) in the operation in the normal mode (non-embossed paper mode) and becomes 3.78 mm in the operation in the embossed paper mode. In this case, for example, in a constitution in which the offset amount X is -2.0 mm to 2.5 mm, in the operation in the embossed paper mode, the curvature of the recording material P in the secondary transfer nip N2 can be made 25m-1 or more.

Incidentally, as described above, a setting (selection) of the image forming mode may also be made by the external device.

Further, description was made on the assumption that the penetration amount Y is set correspondingly to the image forming mode, but the penetration amount Y may also be set correspondingly to the kind of the recording material P used in the image formation. In this case, by inputting (selecting) information on the kind of the recording material P (a basis weight of the recording material, whether or not the recording material P is the embossed paper, or the like), the controller 200 executes an operation for changing the penetration amount Y depending on the kind of the recording material P. Further, the controller 200 may also execute the operation for changing the penetration amount Y on the basis of the information on the kind of the recording material P included in information on the job inputted from the external device to the controller 200. In a case of job including recording materials P which are the recording materials of a plurality of kinds and which are desired that the penetration amount Y is changed, during the job, the penetration amount Y can be changed in the sheet interval step or the like.

### Specific example 2

Depending on rigidity of the recording material P, behavior of the recording material P in the neighborhoods of positions upstream and downstream of the secondary transfer nip N2 with respect to the conveying direction of the recording material P is changed in some instances. For example, depending on the rigidity of the recording material P, when a leading end or a trailing end of the recording material P enters the secondary transfer nip N2, an image defect ("shock image") at a leading/trailing end of the recording material P) due to vibration of the intermediary transfer belt 7 in the neighborhood of the position upstream of the secondary transfer nip N2 becomes liable to occur in some instances. There is a tendency that the shock image is liable to occur with higher rigidity of the recording material P, i.e., with a larger basis weight (thickness) of the recording material P.

On the other hand, when the pressing member 26 contacts the intermediary transfer belt 7 and presses the intermediary transfer belt 7 with a predetermined pressing force, the stretched surface T of the intermediary transfer belt 7 is changed, so that tension in the neighborhood of the secondary transfer nip N2 becomes strong. By this, vibration of the intermediary transfer belt 7 can be suppressed, so that it becomes possible to alleviate the "shock image" at the leading/trailing ends of the recording material P.

Further, for example, in the case of the "thick paper" which is an example of the recording material P having high rigidity, a gap is liable to occur between the intermediary transfer belt 7 and the recording material P in the neighborhood of the entrance of the secondary transfer nip N2, so that "scattering" becomes liable to occur. This will be further descried with reference to part (b) of FIG. 18. Part (b) of FIG. 18 is a schematic sectional view (cross section substantially perpendicular to the rotational axis direction of the inner roller 21) for illustrating a conveying attitude of the recording material P in the neighborhood of the secondary transfer nip N2. In the cross section shown in part (b) of FIG. 18, in the neighborhood of the entrance of the secondary transfer nip N2 (in the neighborhood of the upstream portion of the inner roller 21 with respect to the rotational direction of the intermediary transfer belt 7), a distance in which the intermediary transfer belt 7 and the recording material P contact each other along the movement direction of the intermediary transfer belt 7 is defined as a contact distance D. In the case where the recording material P is the "thick paper", the rigidity of the recording material P is high, and therefore, the recording material P is not readily bent in the neighborhood of the secondary transfer nip N2, so that the contact distance D becomes small. For that reason, the gap G is formed between the intermediary transfer belt 7 and the recording material P, and electric discharge occurs in the gap G by the influence of a transfer electric field, so that the toner image scatters and thus the image defect ("scattering") occurs in some instances.

On the other hand, the intermediary transfer belt 7 is projected to the outer peripheral surface side by the pressing member 26, whereby the contact distance D is increased, so that the gap G between the intermediary transfer belt 7 and the recording material P in the neighborhood of the entrance of the secondary transfer nip N2 can be reduced. By this, the "scattering" can be suppressed.

From viewpoints of alleviation of the shock image and the scattering, as the image forming mode, a plurality of image forming modes depending on the basis weight of the recording material P as information relating to the rigidity of the recording material P can be provided. On the other hand, from a viewpoint of alleviation of the transfer void in the embossed paper, which is a viewpoint other than the basis weight of the recording material P, an image forming mode depending on whether or not the recording material P is the embossed paper.

For example, the image forming apparatus 100 may be capable of carrying out the image formation in a thin paper mode (or the normal mode) in which the toner image is transferred onto the recording material P (thin paper or plain paper) which is not the embossed paper and which has a basis weight smaller than a predetermined value (first mode). Further, the image forming apparatus 100 may be capable of carrying out the image formation in a thick paper mode in which the toner image is transferred onto the recording material P which is not the embossed paper and which has a basis weight not less than the above-described predetermined value (second mode). Further, the image forming apparatus 100 may be capable of carrying out the image formation in the embossed paper mode in which the toner image is transferred onto the recording material P which is the embossed paper (third mode). The curvature of the recording material P in the secondary transfer nip N2 in the operation in the third mode is larger than each of the curvature of the recording material P in the secondary transfer nip N2 in the operation in the first mode and the curvature of the recording material P in the secondary transfer nip N2 in the operation in the second mode. Even when the basis weights are the same, it is desirable that the image formation is carried out in the first mode or the second mode in the case of the recording material P which is not the embossed paper and is carried out in the third mode in the case of the recording material P which is the embossed paper.

Part (b) of FIG. 10 is a schematic view showing another example of the operating screen (selecting screen of the image forming mode) 300 displayed on the operating portion 101. The operating screen 300 is displayed on the touch panel of the operating portion 101 similarly as in the case of the example of part (a) of FIG. 10. Further, a predetermined signal is inputted from the operating portion 101 to the controller 200 similarly as in the case of the example of part (a) of FIG. 10. In the example of part (b) of FIG. 10, the operating screen 300 is provided with the selecting portion 301 for selecting either one of the thin paper mode (or the normal mode), the thick paper mode, and the embossed paper mode. In the selecting portion 301, the selected image forming mode is enabled, and a released image forming mode is disabled. Further, the determining portion (OK button) 302 provided on the operating screen 300 is operated, so that a signal indicating that either one of the image forming modes is enabled is outputted from the operating portion 101 to the controller 200. By this, the controller 200 is capable of acquiring an instruction as to whether to execute the image formation in the image forming mode which is either one of the thin paper mode (or the normal mode), the thick paper mode, and the embossed paper mode. That is, the controller 200 is capable of acquiring an instruction as to whether to use either one of the thin paper (or the plain paper), the thick paper, and the embossed paper. Incidentally, the thin paper mode (or the normal mode) can be used as the default mode. Further, on the basis of this information, the controller 200 executes an operation for adjusting the penetration amount Y in the above-described manner.

The controller 200 can control the pressing mechanism 16 so that the penetration amount Y is adjusted depending on the image forming mode in the following manner, for example. As an example, it is assumed that as regards the recording material P which is not the embossed paper, the thin paper mode (or the normal mode) is appropriate in the case where the basis weight is smaller than 100 g/m2, and the thick paper mode is appropriate in the case where the basis weight is 100 g/m2 or more. Further, in this case, the controller 200 can control the pressing mechanism 16 so that the penetration amount Y is 0 mm (separation) in the operation in the thin paper mode (or the normal mode), is 1.75 mm in the thick paper mode, and is 3.78 mm in the embossed paper mode. In this case, for example, when a constitution in which the offset amount X is -2.0 to 2.5 mm is employed, in the operation in the embossed paper mode, the curvature of the recording material P in the secondary transfer nip N2 can be made 25 m-1 or more.

Incidentally, similarly as described for the specific example 1, the setting (selection) of the image forming mode may also be made by the external device. In addition, similarly as described for the specific example 1, the penetration amount Y is not limited to the penetration amount set correspondingly to the image forming mode, but may also be set correspondingly to the kind of the recording material P used in the image formation. Further, as described for the specific example 1, on the basis of information on the kind of the recording material P included in the information on the job inputted from the external device to the controller 200, the controller 200 may execute an operation for changing the penetration amount Y.

As described above, according to this embodiment, it is possible to improve the transfer property of the toner image onto the embossed paper provided with unevenness on the surface on which the toner image is transferred.

### Embodiment 2

Next, another embodiment of the present disclosure will be described. In an image forming apparatus of this embodiment, elements having functions or constitutions, which are identical or corresponding to those of the image forming apparatus of the embodiment 1 will be omitted from detailed description by adding thereto the same reference numerals or symbols as those in the embodiment 1.

In the embodiment 1, the image forming apparatus 100 employed the constitution in which the offset amount X showing the relative position between the inner roller 21 and the outer roller 9 with respect to the circumferential direction of the inner roller 21 is a constant value, but in this embodiment, a constitution in which the offset amount X is changeable is employed. The definition of the offset amount X is as described in the embodiment 1.

1. Offset mechanism

With reference to (a) and (b) of FIG. 5, the offset mechanism 17 will be described. Parts (a) and (b) of FIG. 5 are schematic side views, for illustrating the offset mechanism 17, of a principal part of a portion in the neighborhood of the secondary transfer nip N2 as seen from a one end portion side (front side on the drawing sheet of FIG. 1) with respect to a rotational axis direction of the inner roller 21 in a direction substantially parallel to the rotational axis direction. Part (a) of FIG. 5 shows a state in which the offset amount X is relatively small, and part (b) of FIG. 5 shows a state in which the offset amount X is relatively large. In parts (a) and (b) of FIG. 5, a constitution in the one end portion of the inner roller 21 with respect to the rotational axis direction of the inner roller 21 is shown, but a constitution in the other end portion of the inner roller 21 is similar thereto (i.e., is substantially symmetrical therewith with respect to a center in the rotational axis direction of the inner roller 21). Incidentally, in this embodiment, description will be made on the assumption that the image forming apparatus 100 is not provided with the pressing member 26, but a constitution in which the pressing member 26 is provided and in which the penetration amount of the pressing member 26 at least during the image formation is fixed to a predetermined amount may also be employed.

As shown in parts (a) and (b) of FIG. 5, in this embodiment, the image forming apparatus 100 includes the offset mechanism 17 as a position changing mechanism for changing the offset amount X (position of the secondary transfer nip N2 with respect to the circumferential direction of the inner roller 21) by changing the position of the inner roller 21.

Opposite end portions of the inner roller 21 with respect to the rotational axis direction are supported (held) by an inner roller holder 31 as a supporting member (holding member). The inner roller holder 31 is supported by a frame or the like of the intermediary transfer belt unit 20 so as to be capable of being slid and moved substantially parallel to the stretched surface T of the intermediary transfer belt 7 formed between the inner roller 21 and the pre-secondary transfer roller 24. Incidentally, the inner roller holder 31 may also be supported by the frame or the like so as to be rotatable about an inner roller rotation shaft. Thus, the inner roller 21 is moved by moving the inner roller holder 31, so that the offset amount X can be changed by changing the relative position of the inner roller 21 to the outer roller 9.

The inner roller holder 31 is constituted so as to be rotated by the action of an offset cam 37 as an acting member. The offset cam 37 is supported by the frame or the like of the intermediary transfer belt unit 20 so as to be rotatable about the offset cam rotation shaft 37a. The offset cam 37 is rotated about the offset cam rotation shaft 37a by receiving drive from an offset cam driving motor 213 as a driving source. Further, the offset cam 37 contacts a cam follower 31a provided to the inner roller holder 31. Further, the inner roller holder 31 may be urged by a tensile spring (not shown) or the like which is an urging member (elastic member) as an urging means so that the cam follower 31a is moved in a direction in which the cam follower 31a engages with the offset cam 37. Incidentally, there is a case where a sufficient force for moving the inner roller holder 31 in a direction in which the cam follower 31a engages with the offset cam 37 can be obtained by the tension of the intermediary transfer belt 7 or the pressing by the outer roller 9. In this case, the above-described spring is not required to be provided. Further, in this embodiment, the image forming apparatus 100 is provided with an offset cam position sensor (cam HP sensor) 214 as a position detecting means for detecting a position of the offset cam 37 with respect to the rotational direction, particularly a home position (HP) with respect to the rotational direction. The offset cam position sensor 214 can be constituted by including, for example, a flag as an indicating portion provided on or coaxially with the offset cam 37, a photo-interrupter as a detecting portion, and the like.

Thus, in this embodiment, the offset mechanism 17 is constituted by including the inner roller holder 31, the offset cam 37, the offset cam driving motor 213, the offset cam position sensor 214, and the like.

As shown in part (a) of FIG. 5, in the case where the offset amount X is made relatively small, the offset cam 37 is driven by the offset cam driving motor 213 and is rotated in the counterclockwise direction. By this, the inner roller holder 31 is moved toward the upstream side in the rotational direction of the intermediary transfer belt 7, so that the relative position of the inner roller 21 to the outer roller 9 is determined. By this, a state in which the inner roller 21 is disposed in a position where the offset amount X is relatively small is formed.

As shown in part (b) of FIG. 5, in the case where the offset amount X is made relatively large, the offset cam 37 is rotated in the clockwise direction by being driven by the offset cam driving motor 213. By this, the inner roller holder 38 is moved toward the downstream side in the rotational direction of the intermediary transfer belt 7, so that the relative position of the inner roller 21 to the outer roller 9 is determined. By this, a state in which the inner roller 21 is disposed in a position where the offset amount X is relatively large is formed.

As shown in part (b) of FIG. 5, when the offset amount X is made a positive value, the stretched surface T of the intermediary transfer belt 7 is changed, so that the shape of the intermediary transfer belt 7 in the neighborhood of the secondary transfer nip N2 changes in direction in which the intermediary transfer belt 7 is wound about the outer roller 9. As described above, by changing the offset amount X, a curvature of the recording material P in the secondary transfer nip N2 can be changed.

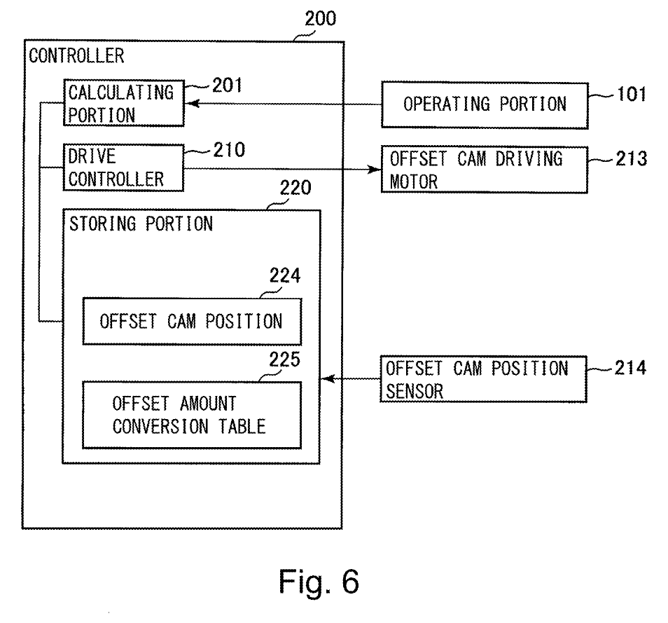

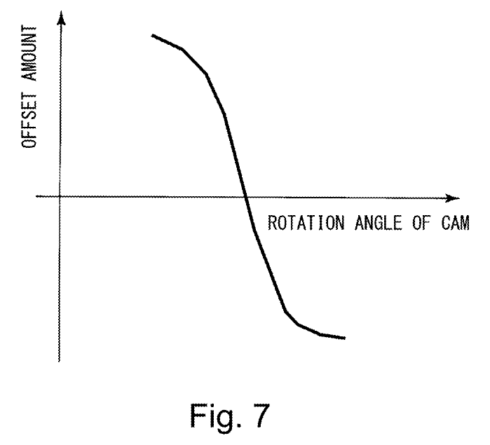

Further, in this embodiment, the offset cam 37 has a shape such that the position of the inner roller 21 changes depending on an angle of rotation. By this, in this embodiment, by controlling the angle of rotation of the offset cam 37, it becomes possible to adjust the offset amount X. In this embodiment, the controller 200 (FIG. 6) controls the offset cam driving motor 213, and thus controls the position of the inner roller 9 so that the offset amount X becomes a desired offset amount X. FIG. 7 is a graph showing a relationship between the angle of rotation of the offset cam 37 and the offset amount X.

In this embodiment, an initial set value (predetermined pressing force) of the pressing member 26 into the intermediary transfer belt 7 is set to, for example, a negative predetermined value or a positive predetermined value. Further, in this embodiment, it becomes possible to set the offset amount X to -3.0 mm to +3.0 mm. Incidentally, the present disclosure is not limited thereto, but this offset amount X may suitably be about -5.0 mm to +5.0 mm.

Incidentally, the offset amount X may only be required to become a desired value when the recording material P passes through the secondary transfer nip N2 (during the secondary transfer).

2. Control mode

FIG. 6 is a schematic block diagram showing a control mode of a principal portion of the image forming apparatus 100 in this embodiment. In FIG. 6, to elements having functions and constitutions, which are identical or corresponding to those shown in FIG. 3, the same reference numerals or symbols are added. In this embodiment, to the controller 200, the offset cam driving motor 213 and the offset cam position sensor 214 are connected. In this embodiment, by an instruction from the calculating (arithmetic) portion 201, the drive controller 210 operates driving means of the respective portions of the image forming apparatus 100, such as the offset cam driving motor 213. In this embodiment, during the non-image formation, typically in the stand-by state, the image forming apparatus 100 is capable of executing an operation for adjusting offset amount X.

3. Adjustment of offset amount

Next, an adjusting method of the offset amount X (position of the inner roller 21) in this embodiment will be specifically described.

As shown in FIG. 6, in this embodiment, in the storing portion 220, offset cam position information 224 acquired from the offset cam position sensor 214 for detecting the home position (HP) of the offset cam 37 is stored. Further, in this embodiment, in the storing portion 220, an offset amount conversion table 225 for rotationally driving the offset cam 37 to a predetermined position is stored.

The offset amount conversion table 225 shows a relationship between the angle of rotation of the offset cam 37 and the offset amount X as shown in FIG. 7. On the basis of the offset amount conversion table 225 and the offset cam position information 224, the arithmetic portion 201 acquires the angle of rotation of the offset cam 37 necessary to adjust the offset amount X to a predetermined offset amount X. Then, depending on a result thereof, the offset cam 37 is rotated by operating the offset cam driving motor 213 by a necessary control amount by the drive controller 210.

In this embodiment, as described later, the user provides an instruction from an input portion of the operating portion 101 to the controller 200 so as to perform an operation in an image forming mode. Further, the arithmetic portion 201 of the controller 200 reflects information on the offset amount X corresponding to the image forming mode designated by the user through the input portion of the operating portion 101 in an operation of the offset cam driving motor 213. The information on the offset amount X corresponding to each image forming mode is set in advance and stored in the storing portion 220. Incidentally, in this embodiment, an instruction on selection of the operation in the image forming mode is provided from the operating portion 101. In this case, the operating portion 101 functions as an acquiring portion for acquiring information on the kind of the recording material P on which the image is formed. Further, in this case, the operating portion 101 can be said that the operating portion 101 functions as the input portion for inputting the information on the kind of the recording material P on which the image is formed, to the controller 200. However, the instruction on selection of the operation in the image forming mode may be provided from the external device communication connected to the image forming apparatus 100. In this case, the above-described interface portion (input/output circuit) or the like functions as the acquiring portion for acquiring the information on the kind of the recording material P on which the image is formed. Further, in this case, the interface portion (input/output circuit) or the like can also be said that the interface portion functions as the input portion for inputting the information on the kind of the recording material P on which the image is formed, to the controller 200.

4. Image formation on embossed paper

Next, in this embodiment, an example of a method in which the curvature of the recording material P in the secondary transfer nip N2 is changed when the toner image is transferred onto the embossed paper will be described.

### Specific example 3

Similarly as the specific example 1 described in the embodiment 1, the image forming apparatus 100 is capable of forming an image in an operation in a normal mode (first mode) in which the toner image is transferred onto the recording material P which is not the embossed paper and in an operation in an embossed paper mode (second mode) in which the toner image is transferred onto the recording material P which is the embossed paper. The curvature of the recording material P in the secondary transfer nip N2 in the operation in the second mode is larger than the curvature of the recording material P in the secondary transfer nip N2 in the operation in the first mode. In this case, similarly as the specific example 1 described in the embodiment 1, for example, the image forming mode is selected by the operating screen (selecting screen of the image forming mode) 300 shown in part (a) of FIG. 10. Further, on the basis of information on the selected image forming mode, the controller 200 executes the operation for adjusting the offset amount X in the above-described manner.

For example, the controller 200 is capable of controlling the offset mechanism 17 so that the offset amount X is adjusted in the following manner depending on the image forming mode. That is, as an example, the controller 200 is capable of controlling the offset mechanism 17 so that the offset amount X becomes -2.0 mm (or 0 mm) in the operation in the normal mode (non-embossed paper mode) and becomes +2.5 mm in the operation in the embossed paper mode. In this case, for example, in a constitution in which the penetration amount Y is larger than 1.75 mm (for example, in a constitution in which the penetration amount Y is 1.80 mm or more), in the operation in the embossed paper mode, the curvature of the recording material P in the secondary transfer nip N2 can be made 25m-1 or more.

Incidentally, similarly as described for the specific example 1 in the embodiment 1, a setting (selection) of the image forming mode may also be made by the external device. Further, similarly as described for the specific example 1 in the embodiment 1, the offset amount X is not limited to that the offset amount X is set correspondingly to the image forming mode, and the offset amount X may also be set correspondingly to the kind of the recording material P used in the image formation. Further, similarly as described for the specific example 1 in the embodiment 1, the controller 200 may also execute the operation for changing the offset amount X on the basis of the information on the kind of the recording material P included in information on the job inputted from the external device to the controller 200.

### Specific example 4

As described above, depending on rigidity of the recording material P, behavior of the recording material P in the neighborhoods of positions upstream and downstream of the secondary transfer nip N2 with respect to the conveying direction of the recording material P is changed in some instances.

For example, in the case of the "thin paper" which is an example of the recording material P having low rigidity, the intermediary transfer belt 7 and the recording material P are adhered in the neighborhood of a position downstream of the secondary transfer nip N2 with respect to the conveying direction of the recording material P, so that a jam occurs due to "separation failure" of the recording material P from the intermediary transfer belt 7 in some instances. This will be further described with reference to part (a) of FIG. 18. Part (a) of FIG. 18 is a schematic sectional view (cross section substantially perpendicular to the rotational axis direction of the inner roller 21) for illustrating behavior of the recording material P in the neighborhood of the secondary transfer nip N2. This phenomenon becomes conspicuous in the case where the rigidity of the recording material P is low because the recording material P becomes liable to adhere to the intermediary transfer belt 7 due to weak resilience of the recording material P. That is, in a cross section shown in part (a) of FIG. 18, a line showing the stretched surface of the intermediary transfer belt 7 formed by being stretched by the inner roller 21 and the pre-secondary transfer roller 24 is defined as a stretched line T. Further, in the cross section, a rectilinear line passing through a rotation center of the inner roller 21 and a rotation center of the outer roller 9 is defined as a nip center line Lc. Further, in the cross section, a line substantially perpendicular to the nip center line Lc is defined as a nip line Ln. Incidentally, part (a) of FIG. 18 shows a state in which with respect to a direction along the stretched line T, the rotation center of the outer roller 9 is offset and disposed on a side upstream of the rotational direction of the intermediary transfer belt 7 than the rotation center of the inner roller 21. At this time, in a state in which the recording material P is nipped between the inner roller 21 and the outer roller 9 in the secondary transfer nip N2, the recording material P has a tendency to keep an attitude thereof substantially along the nip line Ln. For that reason, in general, in the case where the rotation center of the inner roller 21 and the rotation center of the outer roller 9 are close to each other with respect to the direction along the stretched line T, as shown by broken line A in part (a) of FIG. 18, a discharge angle θ of the recording material P becomes small. That is, a leading end of the recording material P with respect to the conveying direction takes an attitude such that the recording material P is discharged near to the intermediary transfer belt 7 when the recording material P is discharged from the secondary transfer nip N2. By this, the recording material P is liable to adhere to the intermediary transfer belt 7, so that the "separation failure" of the recording material P from the intermediary transfer belt 7 is liable to occur.

On the other hand, in general, as shown by solid line in part (a) of FIG. 18, the discharge angle θ of the recording material P becomes large with an arrangement of the rotation center of the outer roller 9 with respect to the direction along the stretched line T on a more upstream side than the rotation center of the inner roller 21 with respect to the rotational direction of the intermediary transfer belt 7. That is, the leading end of the recording material P with respect to the conveying direction takes an attitude such that the recording material P is discharged in a direction in which the recording material P is separated from the intermediary transfer belt 7 when the recording material P is discharged from the secondary transfer nip N2. By this, the recording material P becomes hard to adhere to the intermediary transfer belt 7, so that a "separation property" of the recording material P from the intermediary transfer belt 7 is improved. That is, the offset amount X is made relatively large, so that it becomes possible to improve the separation property of the recording material P from the intermediary transfer belt 7.

On the other hand, for example, in the case where the recording material P is the "thick paper" which is an example of the recording material P high in rigidity, when a trailing end of the recording material P with respect to the conveying direction passed through the conveying guide 14, a trailing end portion of the recording material P with respect to the conveying direction collides with the intermediary transfer belt 7 in some instances. By this, an image defect ("flip-up") occurs in the trailing end portion of the recording material P with respect to the conveying direction in some instances. This phenomenon becomes conspicuous in the case where the rigidity of the recording material P is high because the trailing end portion of the recording material P with respect to the conveying direction becomes liable to strongly collide with the intermediary transfer belt 7 due to high resilience of the recording material P. That is, as described above, in the cross section shown in part (a) of FIG. 18, in a state in which the recording material P is nipped between the inner roller 21 and the outer roller 9 in the secondary transfer nip N2, the recording material P has a tendency to keep an attitude thereof substantially along the nip line Ln.

For that reason, in general, the nip line Ln bites into the stretched line T with the arrangement of the outer roller 9 with respect to the direction along the stretched line on a more upstream side than the rotation center of the inner roller 21 with respect to the rotational direction of the intermediary transfer belt 7. As a result, when the trailing end of the recording material P with respect to the conveying direction passed through the conveying guide 14, as shown by a broken line B in part (a) of FIG. 18, the trailing end portion of the recording material P with respect to the conveying direction collides with the intermediary transfer belt 7, so that the image defect ("flip-up") becomes liable to occur in the trailing end portion of the recording material P with respect to the conveying direction.

On the other hand, in general, when the rotation center of the inner roller 21 and the rotation center of the outer roller 9 are made close to each other with respect to the direction along the stretched line T, collision of the trailing end of the recording material P with respect to the conveying direction with intermediary transfer belt 7 when the recording material trailing end passed through the conveying guide 14 is suppressed. By this, the image defect ("flip-up") of the trailing end portion of the recording material P with respect to the conveying direction becomes hard to occur. That is, the offset amount X is made relatively small, so that it becomes possible to suppress the flip-up.

From viewpoints of the above-described separation property and the flip-up, as the image forming mode, a plurality of image forming modes depending on the basis weight of the recording material P as information relating to the rigidity of the recording material P can be provided.

On the other hand, from a viewpoint of alleviation of the transfer void in the embossed paper, which is a viewpoint other than the basis weight of the recording material P, an image forming mode depending on whether or not the recording material P is the embossed paper.

For example, the image forming apparatus 100 may be capable of carrying out the image formation in a thin paper mode in which the toner image is transferred onto the recording material P (thin paper) which is not the embossed paper and which has a basis weight smaller than a predetermined value (first mode). Further, the image forming apparatus 100 may be capable of carrying out the image formation in a thick paper mode (or the normal mode) in which the toner image is transferred onto the recording material P which is not the embossed paper and which has a basis weight not less than the above-described predetermined value (second mode). Further, the image forming apparatus 100 may be capable of carrying out the image formation in the embossed paper mode in which the toner image is transferred onto the recording material P which is the embossed paper (third mode). The curvature of the recording material P in the secondary transfer nip N2 in the operation in the third mode is larger than each of the curvature of the recording material P in the secondary transfer nip N2 in the operation in the first mode and the curvature of the recording material P in the secondary transfer nip N2 in the operation in the second mode. Even when the basis weights are the same, it is desirable that the image formation is carried out in the first mode or the second mode in the case of the recording material P which is not the embossed paper and is carried out in the third mode in the case of the recording material P which is the embossed paper.

In this case, similarly as the specific example 2 described in the embodiment 1, for example, the image forming mode is selected by the operating screen (selecting screen of the image forming mode) 300 shown in part (b) of FIG. 10. Further, on the basis of information on the selected image forming mode, the controller 200 executes an operation for adjusting the offset amount X in the above-described manner.

The controller 200 can control the offset mechanism 17 so that the offset amount X is adjusted depending on the image forming mode in the following manner, for example. As an example, it is assumed that as regards the recording material P which is not the embossed paper, the thin paper mode is appropriate in the case where the basis weight is smaller than 52 g/m2, and the thick paper mode (or the normal mode) is appropriate in the case where the basis weight is 52 g/m2 or more. Further, in this case, the controller 200 can control the offset mechanism 17 so that the offset amount X is 0 mm (separation) in the operation in the thin paper mode, is -2.0 mm in the thick paper mode (or the normal mode), and is +2.5 mm in the embossed paper mode. In this case, for example, when a constitution in which the penetration amount Y is larger than 1.75 mm (for example, a constitution in which the penetration amount Y is 1.80 mm or more) is employed, in the operation in the embossed paper mode, the curvature of the recording material P in the secondary transfer nip N2 can be made 25 m-1 or more.

Incidentally, similarly as described for the specific example 3, the setting (selection) of the image forming mode may also be made by the external device. In addition, similarly as described for the specific example 3, the offset amount X is not limited to the offset amount set correspondingly to the image forming mode, but may also be set correspondingly to the kind of the recording material P used in the image formation. Further, as described for the specific example 3, on the basis of information on the kind of the recording material P included in the information on the job inputted from the external device to the controller 200, the controller 200 may execute an operation for changing the offset amount X.

As described above, according to this embodiment, it is possible to improve the transfer property of the toner image onto the embossed paper provided with unevenness on the surface on which the toner image is transferred.

### Embodiment 3

Next, another embodiment of the present disclosure will be described. In an image forming apparatus of this embodiment, elements having functions or constitutions, which are identical or corresponding to those of the image forming apparatuses of the embodiments 1 and 2 will be omitted from detailed description by adding thereto the same reference numerals or symbols as those in the embodiments 1 and 2.

1. Outline of constitution of image forming apparatus of this embodiment

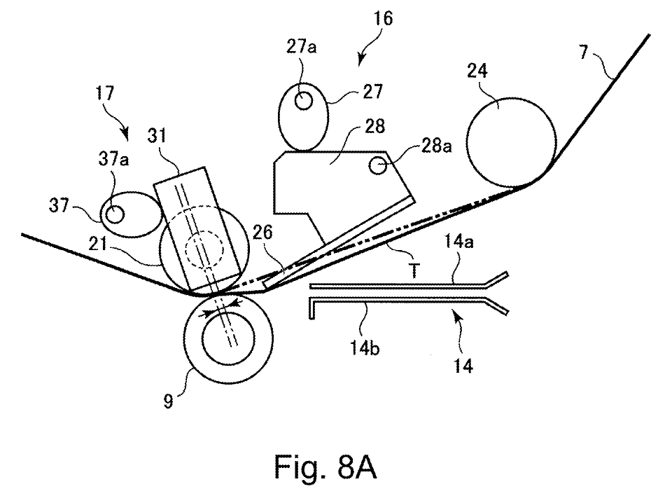

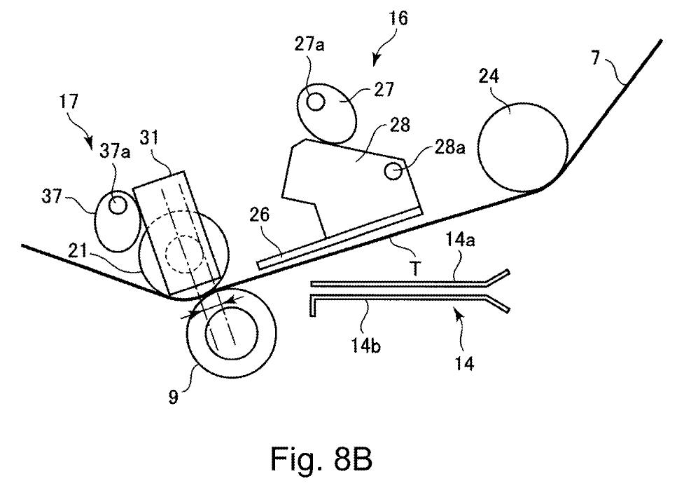

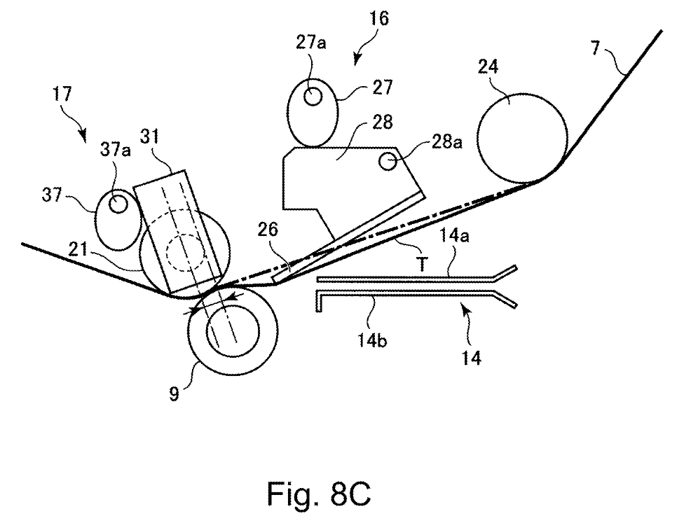

FIG. 8A, FIG. 8B, and FIG. 8C are schematic side views, of a principal part of a portion in the neighborhood of the secondary transfer nip N2 in this embodiment as seen from a one end portion side (front side on the drawing sheet of FIG. 1) with respect to a rotational axis direction of the inner roller 21 in a direction substantially parallel to the rotational axis direction. In this embodiment, the image forming apparatus 100 includes the pressing mechanism 16 and the offset mechanism 17 described in the embodiments 1 and 2, respectively. FIG. 8A shows a state in which the pressing member 26 presses the intermediary transfer belt 7 with a predetermined pressing force and in which the offset amount X is relatively small. FIG. 8B shows a state in which the pressing member 26 is separated from the intermediary transfer belt 7 and in which the offset amount X is relatively large. FIG. 8C shows a state in which the pressing member 26 presses the intermediary transfer belt 7 with a predetermined pressing force and in which the offset amount X is large. In FIG. 8A, FIG. 8B, and FIG. 8C, a constitution in the one end portion of the inner roller 21 with respect to the rotational axis direction of the inner roller 21 is shown, but a constitution in the other end portion of the inner roller 21 is similar thereto (i.e., is substantially symmetrical therewith with respect to a center in the rotational axis direction of the inner roller 21). Further, in this embodiment, the image forming apparatus 100 is capable of changing the penetration amount Y and the offset amount X on the basis of the information on the image forming mode.

2. Control mode

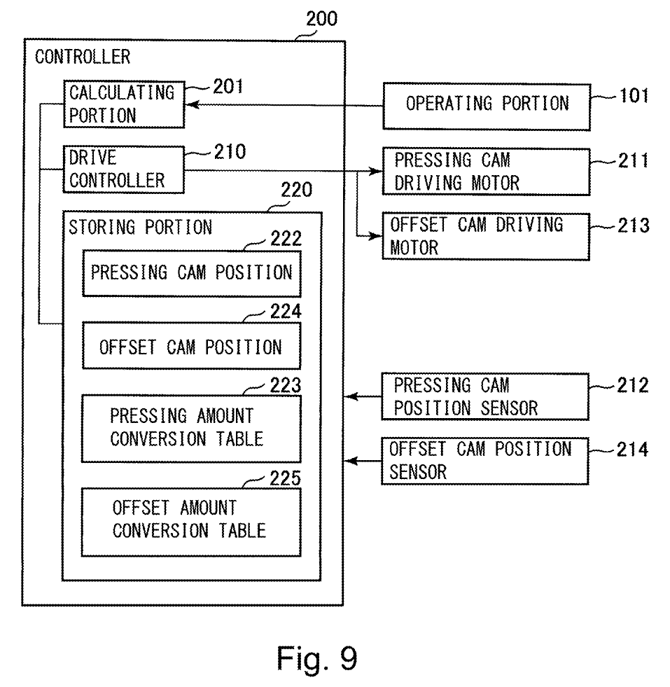

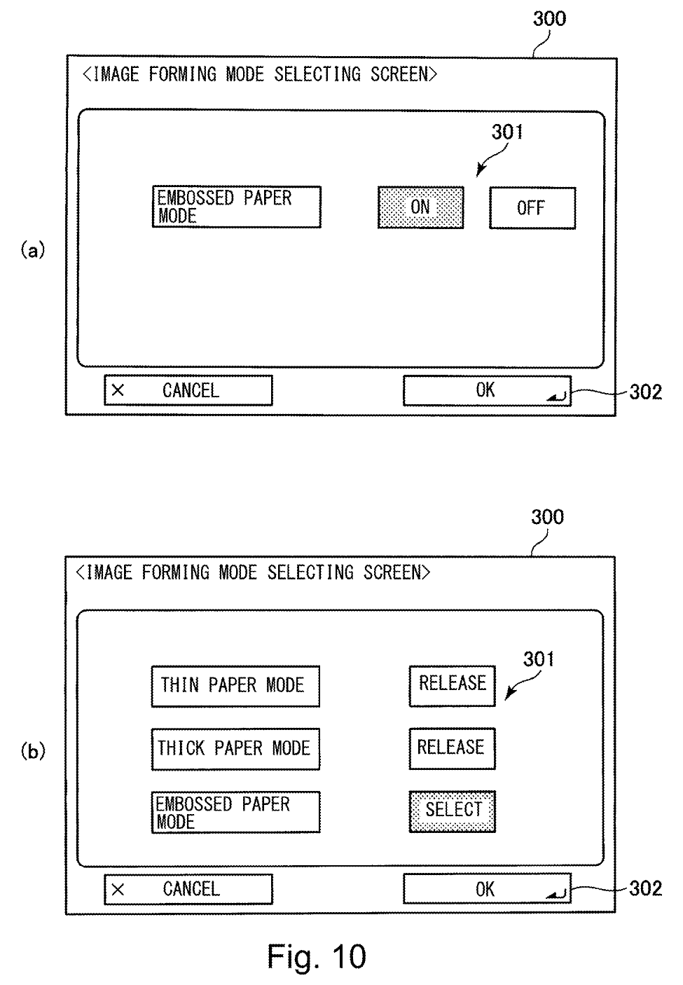

FIG. 9 is a schematic block diagram showing a control mode of a principal portion of the image forming apparatus 100 in this embodiment. In FIG. 9, to elements having functions and constitutions, which are identical or corresponding to those shown in FIGS. 3 and 6, the same reference numerals or symbols are added. In this embodiment, the controller 200 is capable of operating, the pressing cam driving motor 211 and the offset cam driving motor 213 similarly as described in the embodiments 1 and 2, respectively. In this embodiment, during the non-image formation, typically in the stand-by state, the image forming apparatus 100 is capable of executing an operation for adjusting each of the penetration amount Y and offset amount X.

3. Image formation on embossed paper

Next, in this embodiment, an example of a method in which the curvature of the recording material P in the secondary transfer nip N2 is changed when the toner image is transferred onto the embossed paper will be described.

### Specific example 5

Similarly as the specific example 1 described in the embodiment 1, the image forming apparatus 100 is capable of forming an image in an operation in a normal mode (first mode) in which the toner image is transferred onto the recording material P which is not the embossed paper and in an operation in an embossed paper mode (second mode) in which the toner image is transferred onto the recording material P which is the embossed paper. The curvature of the recording material P in the secondary transfer nip N2 in the operation in the second mode is larger than the curvature of the recording material P in the secondary transfer nip N2 in the operation in the first mode.

In this case, similarly as the specific example 1 described in the embodiment 1, for example, the image forming mode is selected by the operating screen (selecting screen of the image forming mode) 300 shown in part (a) of FIG. 10. Further, on the basis of information on the selected image forming mode, the controller 200 executes the operation for adjusting the offset amount X and the penetration amount Y in the above-described manner.

For example, the controller 200 is capable of controlling the offset mechanism 17 and the pressing mechanism 16 so that the offset amount X and the penetration amount Y are adjusted in the following manner depending on the image forming mode. That is, as an example, the controller 200 is capable of controlling the offset mechanism 17 and the pressing mechanism 16 so that the offset amount X becomes -2.0 mm and the penetration amount Y becomes 1.75 mm in the operation in the normal mode (non-embossed paper mode). Further, in the embossed paper mode, the controller 200 is capable of controlling the offset mechanism 17 and the pressing mechanism 16 so that the offset amount X becomes +2.5 mm and the penetration amount Y becomes 3.78 mm in the operation in the embossed paper mode. In this case, in the operation in the embossed paper mode, the curvature of the recording material P in the secondary transfer nip N2 can be made 25m-1 or more. Thus, in the constitution of the specific example 5, in the operation in the normal mode (non-embossed paper mode), irrespective of the basis weight of the recording material P, the offset amount X is set to -2.0 mm, and the penetration amount Y is set to 1.75 mm.

Incidentally, similarly as described for the specific example 1 in the embodiment 1, a setting (selection) of the image forming mode may also be made by the external device. Further, similarly as described for the specific example 1 in the embodiment 1, the offset amount X and the penetration amount Y are not limited to that the offset amount X and the penetration amount Y are set correspondingly to the image forming mode, and the offset amount X and the penetration amount Y may also be set correspondingly to the kind of the recording material P used in the image formation. Further, similarly as described for the specific example 1 in the embodiment 1, the controller 200 may also execute the operation for changing the offset amount X on the basis of the information on the kind of the recording material P included in information on the job inputted from the external device to the controller 200.

### Specific example 6

As described for the specific example 4 in the embodiment 2, for example, in the case of the "thin paper" which is an example of the recording material P having low rigidity, the intermediary transfer belt 7 and the recording material P are adhered in the neighborhood of a position downstream of the secondary transfer nip N2 with respect to the conveying direction of the recording material P, so that a jam occurs due to "separation failure" of the recording material P from the intermediary transfer belt 7 in some instances. On the other hand, the offset amount X is made relatively large, so that the separating property of the recording material P from the intermediary transfer belt 7 can be improved.

However, for example, in the case where the recording material P is the "thin paper", when the offset amount X is made large and the intermediary transfer belt 7 is projected to the outer peripheral surface side thereof by the pressing member 26, the following phenomenon occurs in some instances. That is, the contact distance D described for the specific example 2 in the embodiment 1 becomes excessively large, an image defect, so-called "roughness" (or a "deviation of the toner image"), such that the toner image is disturbed by friction between the toner image on the intermediary transfer belt 7 and the recording material P occurs in some instance.

From viewpoints such as the shock image and the scattering described for the specific example 2 in the embodiment 1, the separation property and the flip-up described for the specific example in the embodiment 2, and the above-described roughness, as the image forming mode, a plurality of image forming modes depending on the basis weight of the recording material P as information relating to the rigidity of the recording material P can be provided. On the other hand, from a viewpoint of alleviation of the transfer void in the embossed paper, which is a viewpoint other than the basis weight of the recording material P, an image forming mode depending on whether or not the recording material P is the embossed paper.

For example, the image forming apparatus 100 may be capable of carrying out the image formation in the thin paper mode in which the toner image is transferred onto the recording material P (thin paper) which is not the embossed paper and which has a basis weight smaller than a predetermined value (first mode). Further, the image forming apparatus 100 may be capable of carrying out the image formation in the thick paper mode (or the normal mode) in which the toner image is transferred onto the recording material P which is not the embossed paper and which has a basis weight not less than the above-described predetermined value (second mode). Further, the image forming apparatus 100 may be capable of carrying out the image formation in the embossed paper mode in which the toner image is transferred onto the recording material P which is the embossed paper (third mode). The curvature of the recording material P in the secondary transfer nip N2 in the operation in the third mode is larger than each of the curvature of the recording material P in the secondary transfer nip N2 in the operation in the first mode and the curvature of the recording material P in the secondary transfer nip N2 in the operation in the second mode. Even when the basis weights are the same, it is desirable that the image formation is carried out in the first mode or the second mode in the case of the recording material P which is not the embossed paper and is carried out in the third mode in the case of the recording material P which is the embossed paper.

In this case, similarly as the specific example 2 described in the embodiment 1, for example, the image forming mode is selected by the operating screen (selecting screen of the image forming mode) 300 shown in part (b) of FIG. 10. Further, on the basis of information on the selected image forming mode, the controller 200 executes an operation for adjusting the offset amount X and the penetration amount Y in the above-described manner.

The controller 200 can control the offset mechanism 17 and the pressing mechanism 16 so that the offset amount X and the penetration amount Y are adjusted depending on the image forming mode in the following manner, for example. As an example, it is assumed that as regards the recording material P which is not the embossed paper, the thin paper mode is appropriate in the case where the basis weight is smaller than 52 g/m2, and the thick paper mode (or the normal mode) is appropriate in the case where the basis weight is 52 g/m2 or more. Further, in this case, the controller 200 can control the offset mechanism 17 and the pressing mechanism 16 so that the offset amount X is +2.5 mm and the penetration amount Y is 0 mm (separation) in the operation in the thin paper mode. Further, the controller 200 can control the offset mechanism 17 and the pressing mechanism 16 so that the offset amount X is -2.0 mm and the penetration amount Y is 1.75 mm in the operation in the thick paper mode (or the normal mode). Further, the controller 200 can control the offset mechanism 17 and the pressing mechanism 16 so that the offset amount X is +2.5 mm and the penetration amount Y is 3.78 mm in the operation in the embossed paper mode. In this case, in the operation in the embossed paper mode, the curvature of the recording material P in the secondary transfer nip N2 can be made 25 m-1 or more. Thus, in the operation in the embossed paper mode, either one of the offset amount X and the penetration amount Y may only be required to made larger than that in the operation in each of other image forming modes. By this, in the operation in the embossed paper mode, the curvature of the recording material P in the secondary transfer nip N2 can be made larger than that in the operation in each of other image forming modes. For example, the above-described specific example, the example in which the value of the penetration amount Y in the operation in the embossed paper mode is set larger than the penetration amount Y in the operation in the thick paper mode was cited. However, when the offset amount X in the operation in the embossed paper mode is larger than the offset amount X in the operation in the thick paper mode, the value of the penetration amount Y in the operation in the embossed paper mode may be made smaller than the penetration amount Y in the operation in the thick paper mode.

Incidentally, similarly as described for the specific example 5, the setting (selection) of the image forming mode may also be made by the external device. In addition, similarly as described for the specific example 5, the offset amount X and the penetration amount Y are not limited to those set correspondingly to the image forming mode, but may also be set correspondingly to the kind of the recording material P used in the image formation. Further, as described for the specific example 5, on the basis of information on the kind of the recording material P included in the information on the job inputted from the external device to the controller 200, the controller 200 may execute an operation for changing the offset amount X and the penetration amount Y.

As described above, according to this embodiment, it is possible to improve the transfer property of the toner image onto the embossed paper provided with unevenness on the surface on which the toner image is transferred.

### Other embodiments

The present disclosure was described above based on specific embodiments, but is not limited thereto.

In the above-described embodiments, the constitution in which, the offset amount is changed by changing the position of the inner roller is employed, but a constitution in which the offset amount is changed by changing the position of the outer roller may also be employed. Further, the present disclosure is not limited to a constitution in which either one of the inner roller and the outer roller is moved but may also employ a constitution in which the offset amount is changed by moving both the inner roller and the outer roller.

In the above-described embodiments, as an outer member for forming the secondary transfer nip in cooperation with the inner roller as an inner member, the outer roller directly contacting the outer peripheral surface of the intermediary transfer belt was used. On the other hand, a constitution in which as the outer member, the outer roller and a secondary transfer belt (endless belt-like member) stretched by the outer roller and another roller are used may also be employed. That is, the image forming apparatus may include, as the outer member, the stretching rollers, the outer roller, and the secondary transfer belt stretched between these roller. Further, the outer roller can be contacted to the outer peripheral surface of the intermediary transfer belt through the secondary transfer belt. In such a constitution, by the inner roller contacting the inner peripheral surface of the intermediary transfer belt and the outer roller contacting the inner peripheral surface of the secondary transfer belt, the intermediary transfer belt and the secondary transfer belt are sandwiched, so that the secondary transfer nip is formed. In this case, a contact portion between the intermediary transfer belt and the secondary transfer belt is the secondary transfer nip as the secondary transfer portion. Incidentally, also in this case, the offset amount X is defined by the relative position between the inner roller and the outer roller similarly as described above. Further, the penetration amount Y is also defined similarly as described above by using the reference line L1 formed by the inner roller and the pre-secondary transfer roller and the pressing portion tangential line L4 or by using the reference line L1' formed by the outer roller and the pre-secondary transfer roller and the pressing portion tangential line L4'.

Further, in the above-described embodiments, description of the controller was made that the controller acquires the information on the kind of the recording material on the basis of the input thereof from the operating portion or the external device through the operation by the operator such as the user or the service person. On the other hand, the controller may also acquire the information on the kind of the recording material on the basis of the input of a detection result of the detecting means for detecting the information. For example, a basis weight sensor can be used as a basis weight detecting means for detecting an index value correlating with the basis weight of the recording material. As the basis weight sensor, for example, a basis weight sensor utilizing attenuation of ultrasonic wave has been known. This basis weight sensor includes an ultrasonic generating portion and an ultrasonic receiving portion which are provided so as to sandwich a recording material conveying passage. The basis weight sensor generates the ultrasonic wave from the ultrasonic generating portion and receives the ultrasonic wave attenuated by being passed through the recording material, and then on the basis of attenuation amount of the ultrasonic wave, detects the index value correlating with the basis weight of the recording material. Incidentally, the basis weight detecting means may only be required to be capable of detecting the index value correlating with the basis weight of the recording material and is not limited to the basis weight detecting means utilizing the ultrasonic wave, but may also be a basis weight detecting means utilizing light, for example. Further, the index value correlating the basis weight of the recording material is not limited to the basis weight itself, but may also be a thickness corresponding to the basis weight. That is, a thickness detecting means for detecting an index value correlating with the rigidity of the recording material can be used. Further, the rigidity of the recording material may also be detected more directly by using a rigidity detecting means for detecting the index value correlating with the rigidity of the recording material. Further, a surface property sensor can be used as a smoothness detecting means for detecting an index value correlating with surface smoothness of the recording material capable of being utilized for detecting the paper kind category (whether or not the recording material is the embossed paper). As the surface property sensor, a regularly/irregularly reflected light sensor for reading intensity of regularly reflected light and irregularly reflected light by irradiating the recording material with light has been known. In the case where the surface of the recording material is smooth, the regularly reflected light becomes strong, and in the case where the surface of the recording material is rough, the irregularly reflected light becomes strong. For that reason, the surface property sensor is capable of detecting the index value correlating with the smoothness of the recording material surface by measuring a regularly reflected light quantity and an irregularly reflected light quantity. Incidentally, the smoothness detecting means may only be required to be capable of detecting the index value correlating with the smoothness of the recording material surface and is not limited to the above-described smoothness detecting means using the light quantity sensor, but may also be a smoothness detecting means using, for example, an image-pick up element. The index correlating with the smoothness of the recording material surface is not limited to a value converted to a value in conformity to a predetermined standard such as Bekk smoothness, but may only be required to be a value having a correlation with the smoothness of the recording material surface. These detecting means can be disposed adjacent to the recording material conveying passage on a side downstream of the feeding portion and upstream of the registration rollers with respect to the recording material conveying direction, for example. Further, for example, a detecting means (media sensor) constituted as a single unit including the above-described basis weight sensor, the above-described surface property sensor, and the like. For example, on the basis of a discrimination result of the kind of the recording material acquired by using a recording material discrimination unit disclosed in JP-A 2024-137543, the controller can reflect the result in the operation for changing the penetration amount and the offset amount.

Further, in the above-described embodiments, as the offset mechanism and the pressing mechanism, an actuator for actuating the movable portion by the cam was used, but these mechanisms are not limited thereto. The offset mechanism and the pressing mechanism may only be required to be capable of realizing an operation in conformity to each of the above-described embodiments, and, for example, an actuator for actuating the movable portion by using a solenoid may be used.

Further, in the above-described embodiments, the case where the belt-shaped image bearing member was the intermediary transfer belt was described, but the present disclosure is applicable when an image bearing member constituted by an endless belt for conveying the toner image borne in the image forming position is used. As such a belt-shaped image bearing member, it is possible to cite a photosensitive (member) belt and an electrostatic recording dielectric (member) belt, in addition to the intermediary transfer belt in the above-described embodiments.

Further, the present disclosure can be carried out also in other embodiments in which a part or all of the constitutions of the above-described embodiments are replaced with alternative constitutions thereof. Accordingly, when the image forming apparatus using the belt-shaped image bearing member is used, the present disclosure can be carried out with no distinction as to tandem type/single drum type, a charging type, an electrostatic image forming type, a developing type, a transfer type, and a fixing type. In the above-described embodiments, a principal part relating to the toner image formation/transfer was described principally, but the present disclosure can be carried out in various uses, such as printers, various printing machines, copying machines, facsimile machines, and multi-function machines, by adding necessary device, equipment, and a casing structure.

According to the present disclosure, the transfer property of the toner image onto the embossed paper provided with the unevenness on the surface on which the toner image is transferred can be improved.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2025-027427 filed on February 22, 2025, which is hereby incorporated by reference herein in its entirety.

What is claimed is:

1. An image forming apparatus comprising:
a rotatable endless belt configured to convey a toner image;
a plurality of stretching rollers including an inner roller configured to stretch the belt;
an outer member contacting an outer peripheral surface of the belt and configured to form a transfer portion, in cooperation with the inner roller, where the toner image is transferred from the belt onto a recording material;
a position changing mechanism configured to change a position of the transfer portion with respect to a circumferential direction of the inner roller by changing a position of at least one of the inner roller and the outer member;
an acquiring portion configured to acquire information on whether or not the recording material onto which the toner image is transferred is embossed paper; and
a controller configured to control the position changing mechanism on the basis of the information,
wherein in a cross section perpendicular to a rotational axis direction of the inner roller, when
a tangential line common to the inner roller and an upstream roller on a side where the belt is stretched is defined as a first reference line,
a rectilinear line passing through a rotation center of the inner roller and perpendicular to the first reference line is defined as a second reference line,
a rectilinear line passing through a rotation center of the outer member and perpendicular to the first reference line is defined as a third reference line, and
a distance between the second reference line and the third reference line is defined as an offset amount which is positive value when the third reference line is positioned on a side upstream of the second reference line with respect to a rotational direction of the belt,
the controller is constituted so as to be capable of changing the offset amount on the basis of the information.

2. The image forming apparatus according to claim 1, wherein on the basis of the information,
(i) in a case where the recording material onto which the toner image is transferred is the embossed paper, the controller controls the position changing mechanism so that the offset amount becomes a first offset amount which is a positive value, and
(ii) in a case where the recording material onto which the toner image is transferred is not the embossed paper, the controller controls the position changing mechanism so that the offset amount becomes a second offset amount smaller than the first offset amount.

3. The image forming apparatus according to claim 2, wherein the second offset amount is a negative value or zero.

4. The image forming apparatus according to claim 3, wherein the information is first information, and the acquiring portion is capable of acquiring second information on a basis weight of the recording material, and
wherein the controller is capable of controlling the offset amount on the basis of the first information and the second information, and
(i) in a case where the recording material onto which the toner image is transferred is not the embossed paper and the basis weight is a first basis weight, the controller controls the position changing mechanism so that the offset amount becomes the first offset amount, and
(ii) in a case where the recording material onto which the toner image is transferred is not the embossed paper and the basis weight is a second basis weight larger than the first basis weight, the controller controls the position changing mechanism so that the offset amount becomes the second offset amount.

5. The image forming apparatus according to claim 1, wherein the plurality of stretching rollers include the upstream roller provided upstream of and adjacent to the inner roller with respect to the rotational direction of the belt,
wherein the image forming apparatus further comprises a pressing member provided upstream of the inner roller and downstream of the upstream roller with respect to the rotational direction of the belt, and capable of pressing an inner peripheral surface of the belt,
wherein the position changing mechanism is capable of changing a position of the pressing member,
wherein the information is first information, and the acquiring portion is capable of acquiring second information on a basis weight of the recording material, and
wherein on the basis of the first information and the second information,
(i) in a case where the recording material onto which the toner image is transferred is the embossed paper, the controller controls the position changing mechanism so that the offset amount is a first offset amount which is a positive value and so that the pressing member is contacted to the inner peripheral surface of the belt,
(ii) in a case where the recording material onto which the toner image is transferred is not the embossed paper and the basis weight is a first basis weight, the controller controls the position changing mechanism so that the offset amount is the first offset amount and so that the pressing member is separated from the inner peripheral surface of the belt, and
(iii) in a case where the recording material onto which the toner image is transferred is not the embossed paper and the basis weight is a second basis weight larger than the first basis weight, the controller controls the position changing mechanism so that the offset amount is a second offset amount smaller than the first offset amount and so that the pressing member is contacted to the inner peripheral surface of the belt.

6. The image forming apparatus according to claim 5, wherein on the basis of the first information and the second information,
(i) in a case where the recording material onto which the toner image is transferred is the embossed paper, the controller controls the position changing mechanism so that a pressing amount of the pressing member to the belt becomes a first pressing amount, and
(ii) in a case where the recording material onto which the toner image is transferred is not the embossed paper and the basis weight is the second basis weight, the controller controls the position changing mechanism so that the pressing amount of the pressing member to the belt is a second pressing amount larger than the first pressing amount.

7. The image forming apparatus according to claim 5, wherein the outer member is a transfer roller.

8. The image forming apparatus according to claim 3, wherein on the basis of the information,
(i) in a case where the recording material onto which the toner image is transferred is not the embossed paper, the controller controls the position changing mechanism so that the offset amount becomes the second offset amount irrespective of a basis weight of the recording material, and
(ii) in a case where the recording material onto which the toner image is transferred is the embossed paper, the controller controls the position changing mechanism so that the offset amount becomes the first offset amount.

9. The image forming apparatus according to claim 3, wherein the plurality of stretching rollers include the upstream roller provided upstream of and adjacent to the inner roller with respect to the rotational direction of the belt,
wherein the image forming apparatus further comprises a pressing member provided upstream of the inner roller and downstream of the upstream roller with respect to the rotational direction of the belt, and capable of pressing an inner peripheral surface of the belt,
wherein the position changing mechanism is capable of changing a position of the pressing member,
wherein the information is first information, and the acquiring portion is capable of acquiring second information on a basis weight of the recording material, and
wherein on the basis of the first information and the second information,
(i) in a case where the recording material onto which the toner image is transferred is the embossed paper, the controller controls the position changing mechanism so that the offset amount is the first offset amount and so that a pressing amount of the pressing member to the belt becomes a first pressing amount,
(ii) in a case where the recording material onto which the toner image is transferred is not the embossed paper and the basis weight is a first basis weight, the controller controls the position changing mechanism so that the offset amount is the first offset amount and so that the pressing amount of the pressing member to the belt becomes a second pressing amount smaller than the first pressing amount, and
(iii) in a case where the recording material onto which the toner image is transferred is not the embossed paper and the basis weight is a second basis weight larger than the first basis weight, the controller controls the position changing mechanism so that the offset amount is the second offset amount and so that the pressing amount of the pressing member to the belt becomes a third pressing amount smaller than the first pressing amount.

10. The image forming apparatus according to claim 9, wherein the outer member is a secondary transfer belt.

11. An image forming apparatus comprising:
a rotatable endless belt configured to convey a toner image;
a plurality of stretching rollers configured to stretch the belt and including an inner roller and an upstream roller provided upstream of and adjacent to the inner roller with respect to a rotational direction of the belt;
an outer member contacting an outer peripheral surface of the belt and configured to form a transfer portion, in cooperation with the inner roller, where the toner image is transferred from the belt onto a recording material;
a pressing member provided upstream of the inner roller and downstream of the upstream roller with respect to the rotational direction of the belt and capable of pressing an inner peripheral surface of the belt;
a changing mechanism capable of changing a curvature of the recording material in the transfer portion by changing a position of the transfer portion with respect to a circumferential direction of the inner roller by changing a position of the pressing member or by changing a position of at least one of the inner roller and the outer member; and
a controller configured to be capable of controlling the changing mechanism so that the curvature of the recording material in the transfer portion becomes 25m-1 or more and 100m-1 or less in a case where the recording material onto which the toner image is transferred is embossed paper.

12. The image forming apparatus according to claim 11, wherein in a cross section perpendicular to a rotational axis direction of the inner roller, when
a tangential line common to the inner roller and an upstream roller on a side where the belt is stretched is defined as a first reference line,
a rectilinear line passing through a rotation center of the inner roller and perpendicular to the first reference line is defined as a second reference line,
a rectilinear line passing through a rotation center of the outer member and perpendicular to the first reference line is defined as a third reference line, and
a distance between the second reference line and the third reference line is defined as an offset amount which is positive value when the third reference line is positioned on a side upstream of the second reference line with respect to a rotational direction of the belt,
the outer member is a transfer roller, and
(i) in a case where the recording material onto which the toner image is transferred is the embossed paper, the controller controls the changing mechanism so that a pressing member is contacted to the inner peripheral surface of the belt and so that an offset amount becomes a positive value,
(ii) in a case where the recording material onto which the toner image is transferred is not the embossed paper and a basis weight of the recording material is a first basis weight, the controller controls the changing mechanism so that the pressing member is separated from the inner peripheral surface of the belt and so that the offset amount becomes a positive value, and
(iii) in a case where the recording material onto which the toner image is transferred is not the embossed paper and the basis weight is a second basis weight larger than the first basis weight, the controller controls the changing mechanism so that the pressing member is contacted to the inner peripheral surface of the belt and so that the offset amount becomes a negative value.

13. The image forming apparatus according to claim 11, wherein in a cross section perpendicular to a rotational axis direction of the inner roller, when
a tangential line common to the inner roller and an upstream roller on a side where the belt is stretched is defined as a first reference line,
a rectilinear line passing through a rotation center of the inner roller and perpendicular to the first reference line is defined as a second reference line,
a rectilinear line passing through a rotation center of the outer member and perpendicular to the first reference line is defined as a third reference line, and
a distance between the second reference line and the third reference line is defined as an offset amount which is positive value when the third reference line is positioned on a side upstream of the second reference line with respect to a rotational direction of the belt,
the outer member is a secondary transfer belt, and
(i) in a case where the recording material onto which the toner image is transferred is the embossed paper, the controller controls the changing mechanism so that a pressing amount of the pressing member to the belt is a first pressing amount and so that an offset amount becomes a positive value,
(ii) in a case where the recording material onto which the toner image is transferred is not the embossed paper and a basis weight of the recording material is a first basis weight, the controller controls the changing mechanism so that the pressing amount of the pressing member to the belt is a second pressing amount smaller than the first pressing amount and so that the offset amount becomes a negative value, and
(iii) in a case where the recording material onto which the toner image is transferred is not the embossed paper and the basis weight is a second basis weight larger than the first basis weight, the controller controls the changing mechanism so that the pressing amount of the pressing member to the belt is a third pressing amount smaller than the first pressing amount and so that the offset amount becomes a negative value.
